(19) United States
(12) Patent Application Publication
(10) Pub. No.: US 2009/0271435 A1
(43) Pub. Date: Oct. 29, 2009

(54) DATA MANAGEMENT METHOD, DATA MANAGEMENT PROGRAM, AND DATA MANAGEMENT DEVICE

(76) Inventors: Katsushi YAKO, Yokohama (JP); Michio Iijima, Tokyo (JP); Natsuko Sugaya, Inagi (JP); Shinsuke Ihara, Kawasaki (JP)

Correspondence Address: BRUNDIDGE & STANGER, P.C., 1700 DIAGONAL ROAD, SUITE 330, ALEXANDRIA, VA, 22314, US

(21) Appl. No.: 12/388,726

(22) Filed: Feb. 19, 2009

(30) Foreign Application Priority Data
Apr. 24, 2008 (JP) 2008-114100

(51) Int. Cl. G06F 17/30

(52) U.S. Cl. 707/103 R; 707/203; 707/E17.005; 707/E17.055; 707/200

(57) ABSTRACT

Provided is a data management method. Data corresponds to an entry including a reference to another entry and is managed in a set which is a collection of pieces of the data. The set corresponds to a linked list where the entry corresponding to the data is linked in order of addition of the data. The entry includes an insertion time sequence number inserted into the linked list and information indicating if the data has been deleted from the set. In that case, the entry is separated from the linked list at a predetermined timing. The linked list is traced to refer to the data. When the insertion time sequence number of the reference entry is later than the insertion time sequence number of the entry which has already been referred to, it is judged that the reference entry has been separated from the linked list.

### CLAIM OF PRIORITY

The present application claims priority from Japanese patent application JP 2008-114100 filed on Apr. 24, 2008, the content of which is hereby incorporated by reference into this application.

### BACKGROUND OF THE INVENTION

This invention relates to a technology of managing data.

In the field of data management, a set that is an unordered collection of objects indicating data, and operation means for the set are generally provided to an application. For example, in a relational database (RDB), a table that is an unordered collection of rows serving as objects corresponds to a set according to this invention. In an object oriented database (OODB), terms of objects and sets are directly used. As the operation means for the set, for example, an iterator called a cursor is used for sequentially referring to objects in the set without any omission or overlapping.

Conventionally, in data management means such as an RDBMS, a set has been configured on a hard disk in view of a storage capacity or other factors. In a case where the set is configured on the hard disk, a response of random access to the hard disk is slow. Thus, generally, a block that has an area of a certain size and that is a sequentially accessible continuous area and objects included in the same set are stored close to one another in the block. In this case, reclamation of the area made unnecessary by object deletion is realized by re-storing objects in the block or reclaiming the empty block. To efficiently reutilize a released free area while suppressing a random access frequency, reclaiming and reutilizing in block units are useful. Thus, in free area releasing processing, generally, re-storing of objects is executed over a plurality of blocks, free blocks are generated, and areas are reclaimed in block units. Such processing imposes high loads which necessitate object movement.

Because of recent increases in memory capacity and high-speed access demand, even in the case of the data management module such as the RDBMS, a set may be configured in a main memory. When the set is stored in the main memory, there is almost no performance penalty by random access with respect to sequential access, and thus objects in the set do not have to be stored in adjacent areas for the purpose of high-speed access. In the memory, accordingly, a set is generally configured as a collection of nodes reachable from a specific node by links by using a graph representing a linked list. In the case of deleting an object and reclaiming the area from the set configured by the graph, an inward link that makes a deletion target object reachable is deleted. An area of the deleted area is updated when it is used again, and an outward link for referring to another object from the deletion target object is destroyed.

In time-division use of a processor or an environment of supporting a plurality of processors, there is a possibility that access will be made to the set in parallel from a plurality of threads (process is understood to be a collection of one or more threads). The deletion target object included in the set may be currently referred to from another thread different from a thread which has initiated deletion. If the area is used again and the outward link is destroyed in the state where the deletion target object is being referred to from the different thread, the referring thread may not be able to reach other objects (including those belonging to a reachable object graph) linked by using the pointer. To solve this problem, a method has been proposed which reutilizes the area of the deletion target object after guaranteeing that no other threads are referring to the object. As a simple method, for example, mutually exclusive locks of objects are obtained.

U.S. Pat. No. 5,442,758 discloses another method for guaranteeing that no other threads are referring to a deletion target object. According to a technology disclosed therein, after a link to the deletion target object is deleted from an object graph, the reusing thread waits for threads which has been referring to the deletion target object, and uses an area of the deletion target object again when all threads have finished referring to the deletion target object. Thread execution history is used for detecting completion of referring to the object by the threads.

### SUMMARY OF THE INVENTION

In the case of using a mutually exclusive lock for the object to guarantee that no other thread is referring to the object when the area of the deletion target object is used again, mutually exclusive locks have to be obtained for all threads which access the object including a referring thread. However, the mutually exclusive locks impose large processing loads, and inhibit simultaneous execution of the threads which refer to the same object. A command for mutual exclusion inhibits simultaneous execution of processors in a multiprocessor environment. Thus, object access overheads become high even in an application which performs reference in most cases and an update application where update target object collision is rare.

In the technology disclosed in U.S. Pat. No. 5,442,758, thread state history is monitored assuming that each thread reaches a static state in which it is guaranteed that no target object is being referred to within a predictable and short limited time. However, in sequential reference to the object using the cursor, which is data management means targeted by this invention, the static state of U.S. Pat. No. 5,442,758 is a state where control has shifted to an application program after reception of the sequential referring request of the objects and discovery of a next referable object. In this case, the sequential referring request of the objects using the cursor is controlled by an application, and its timing is not predictable, and may not be short. An example is a case where hardware access or user transaction occurs between continuous sequential referring requests of objects using the cursor. In such a case, with the method of monitoring the static state history of each thread, area reutilization of the deletion target object lags behind, which deteriorates memory use efficiency.

In the case of updating a data structure in an OS disclosed in U.S. Pat. No. 5,442,758, it is suggested that thread execution history has been obtained for another purpose. In this case, there are no additional costs of obtaining thread execution history. However, in a case where the technology disclosed in U.S. Pat. No. 5,442,758 is applied to the data management means of this invention, new processing for obtaining thread execution history has to be added, which therefore generates an overhead in sequential referring processing of objects (data).

The representative aspects of this invention are as follows. That is, there is provided a data management method which is used in a data management device comprising a data storage unit, an object referring module, and an object area reclaim module, and manages data stored in the data storage unit, the data corresponding to an entry which includes a reference to another entry and being managed in a set which is a collection of pieces of the data, the set corresponding to a linked list in which the entry corresponding to the data is linked in order of addition of the data to the set, the entry including an insertion time sequence number inserted into the linked list and deletion identification information indicating whether or not the data has been deleted from the set. The data management method includes the steps of: separating, by the object area reclaim module, the entry from the linked list in a thread different from the thread of the object referring module in a case where the data has been deleted from the set; sequentially referring to, by the object referring module, the data corresponding to the entry by tracing the linked entries from a head entry of the linked list; comparing, by the object referring module, the insertion time sequence number of a reference entry corresponding to the data to be referred to with the insertion time sequence number of an entry linking the reference entry; and sequentially referring to, by the object referring module, the data corresponding to the entry from an entry linked to a referred-to entry in which the data has already been referred to in a case where judging, by the object referring module, that the entry has been deleted from the liked list.

According to the aspect of this invention, even when data (object) included in the collection (set) is deleted without using any mutually exclusive lock, it can be guaranteed that all the data (objects) included in the collection (set) can be referred to.

### BRIEF DESCRIPTION OF THE DRAWINGS

The present invention can be appreciated by the description which follows in conjunction with the following figures, wherein:

FIG. 1 is a diagram illustrating a software module configuration of a data management system according to a first embodiment of this invention;

FIG. 2 is a diagram illustrating a hardware module configuration, the software module configuration and related configurations of the data management system according to the first embodiment of this invention;

FIG. 3 is a diagram illustrating a configuration example of a thread context according to the first embodiment of this invention;

FIG. 4 is a diagram illustrating a configuration of a cursor according to the first embodiment of this invention;

FIG. 5 is a diagram illustrating a data storage form in a data storage unit according to the first embodiment of this invention;

FIG. 6 is a diagram illustrating a configuration example of an entry stored in the data storage unit according to the first embodiment of this invention;

FIG. 7 is a diagram illustrating another configuration example of the entry stored in the data storage unit according to the first embodiment of this invention;

FIG. 8A is a diagram illustrating a set which includes a linked list referred to from a set anchor according to the first embodiment of this invention;

FIG. 8B is a diagram illustrating a state where an object referring module has moved a previous entry pointer of a thread context and the entry corresponding to a current entry pointer according to the first embodiment of this invention;

FIG. 8C is a diagram illustrating a case where an object area reclaim module has separated the entry from a linked list corresponding to a cursor according to the first embodiment of this invention;

FIG. 8D is a diagram illustrating a case where the entry which has been deleted is used again by an object insertion module to be linked to another entry according to the first embodiment of this invention;

FIG. 8E is a diagram illustrating a state where the object referring module has moved the current entry pointer after detection that the deleted entry has been used again according to the first embodiment of this invention;

FIG. 9 is a flowchart illustrating a procedure of initializing a cursor for sequential reference of objects in a set according to the first embodiment of this invention;

FIG. 10 is a flowchart illustrating a procedure of referring to objects in the set by the cursor according to the first embodiment of this invention;

FIG. 11 is a flowchart illustrating a procedure of inserting an object into the set according to the first embodiment of this invention;

FIG. 12 is a flowchart illustrating a procedure of deleting an object from the set according to the first embodiment of this invention;

FIG. 13 is a flowchart illustrating a procedure of reclaiming the area of the deleted entry for reutilization according to the first embodiment of this invention;

FIG. 14 is a flowchart illustrating an acquisition procedure of system time sequence numbers according to the first embodiment of this invention;

FIG. 15 is a diagram illustrating a configuration of software modules in a data management system according to a second embodiment of this invention;

FIG. 16A is a diagram illustrating a configuration example of a transaction management block managed in a transaction pool according to the second embodiment of this invention;

FIG. 16B is a diagram illustrating a configuration example of an entry stored in the data storage unit according to the second embodiment of this invention;

FIG. 17 is a flowchart illustrating a procedure of starting a transaction according to the second embodiment of this invention;

FIG. 18 is a flowchart illustrating a procedure of finishing a transaction according to the second embodiment of this invention;

FIG. 19 is a flowchart illustrating a procedure of referring to objects in the set by the cursor according to the second embodiment of this invention;

FIG. 20 is a flowchart illustrating a procedure of searching for a referable version from a transaction according to the second embodiment of this invention;

FIG. 21 is a flowchart illustrating a procedure of inserting an object into the set according to the second embodiment of this invention;

FIG. 22 is a flowchart illustrating a procedure of updating an object according to the second embodiment of this invention;

FIG. 23 is a flowchart illustrating a procedure of deleting an object from the set according to the second embodiment of this invention; and

FIG. 24 is a flowchart illustrating a procedure of reclaiming an area of a deleted entry for reutilization according to the second embodiment of this invention.

### DETAILED DESCRIPTION OF THE PREFERRED EMBODIMENTS

Preferred embodiments of this invention will specifically be described below.

### First Embodiment

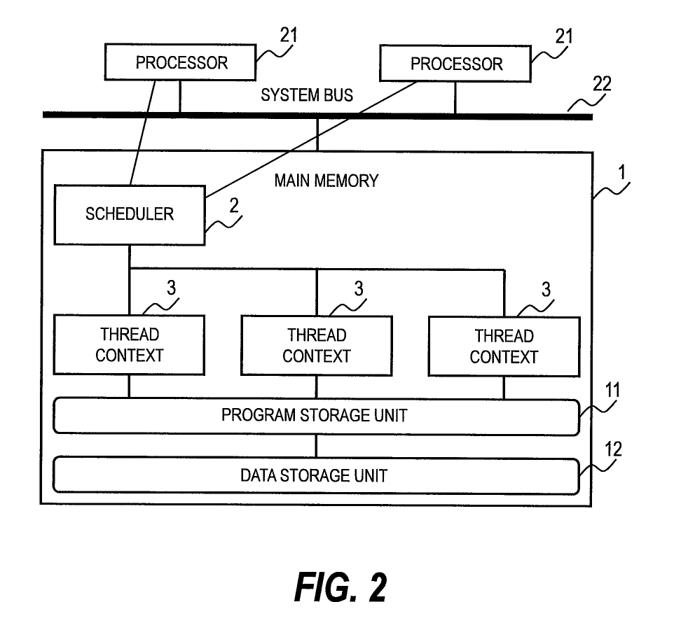

FIG. 2 is a diagram illustrating a hardware module configuration, a software module configuration and related configurations of a data management system according to a first embodiment of this invention.

The data management system of the first embodiment of this invention is a multiprocessor computer system in which each processing is executed by a multithread. A database system operates on the data management system.

The data management system of the first embodiment of this invention includes one or a plurality of processors 21 and a main memory 1. The processor 21 is coupled to the main memory 1 via a system bus 22.

The processor 21 processes a program stored in the main memory 1 to execute various processes. The main memory 1 stores the program and data used in the program. Specifically, the main memory 1 stores a scheduler 2, a thread context 3, a program storage unit 11, and a data storage unit 12.

The thread is a unit for program execution which includes a program counter as an execution step position of a program stored in the program storage unit 11 and sequentially executes steps indicated by the program counter by allocating execution time of the processor 21. In program execution by the thread, data stored in the data storage unit 12 is referred to and updated.

The scheduler 2 controls thread execution by allocating use time of the processor 21 in a time-division manner for each thread context 3. In a case where the time-division processor use time allocated to the thread expires, the scheduler 2 stores current values of the program counter and the register in a corresponding thread context 3 to allocate processor use time to a newly selected thread. In a case where the thread whose processor use time has expired receives a processor use right again, values of the program counter and the register are reclaimed from a corresponding thread context to resume execution of the program steps from a suspended position.

The use time allocation of the processor 21 to the thread by the scheduler 2 is basically executed in a certain short period called a time slice as a unit. According to a situation such as weight-lock waiting of OS resources or response waiting of hardware resources, even during the time slice originally allocated to the thread, processor execution time may be taken from the thread in the midway to be allocated to another thread.

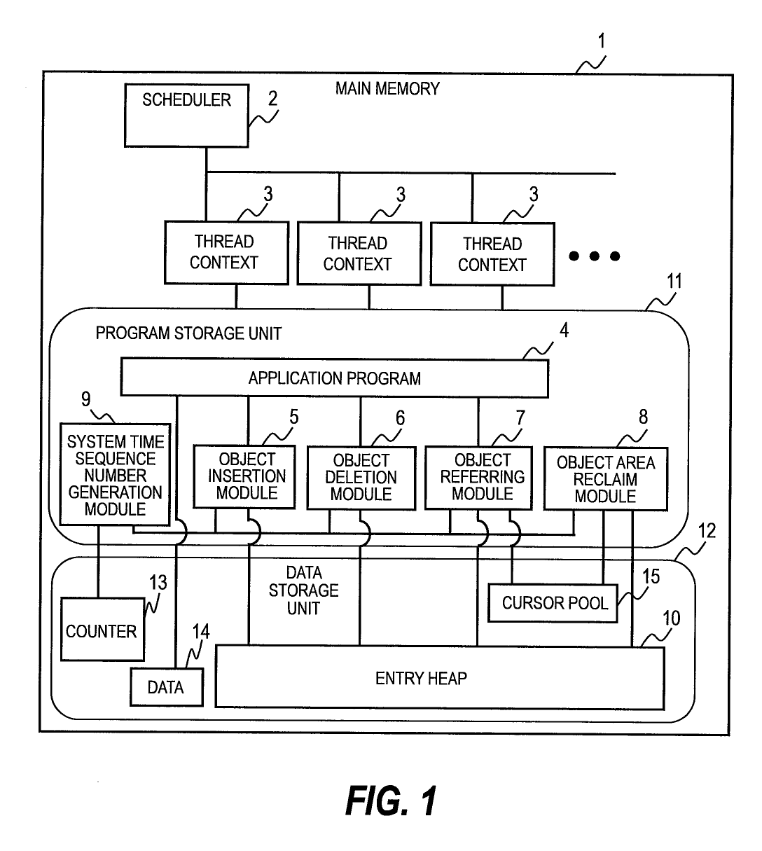

FIG. 1 is a diagram illustrating the software module configuration of the data management system according to the first embodiment of this invention.

As described above, the main memory 1 of the data management system stores the scheduler 2, the thread context 3, the program storage unit 11, and the data storage unit 12.

The program storage unit 11 stores a program which is a collection of steps. Specifically, the program storage unit 11 stores an application program 4, and software modules which are data management means. In the application program 4, a logic for executing intended services by using the data management means is defined.

The software modules that are the data management means include an object insertion module 5, an object deletion module 6, an object referring module 7, and an object area reclaim module 8.

The data storage unit 12 stores an entry heap 10, a counter 13, data 14, and a cursor pool 15.

The object insertion module 5 is a software module which operates in response to a request from the application program 4, and executes a procedure of inserting an object into a set configured as a linked list in the entry heap 10 as a data management means.

The entry heap 10 is a storage area for storing the object, an entry of the linked list corresponding to the object, and a free area for both.

The object deletion module 6 is a software module which operates in response to a request from the application program 4, and executes a procedure of deleting a cursor-indicated object from the set.

The object referring module 7 is a software module which operates in response to a request from the application program 4, and executes a procedure of returning reference to an object included in the set to the application program 4. This procedure includes an object sequential reference start procedure of initializing the cursor, and an object sequential referring procedure using the initialized cursor.

The object area reclaim module 8 is a software module which executes a procedure of reclaiming a deleted object and an area used by the entry which is accessed from none of the threads due to data deletion for reutilization, and managing it as a free area. The object area reclaim module 8 may be executed based on a direct request from the application program 4 or extension of an object insertion request. According to the first embodiment of this invention, however, the object area reclaim module 8 is executed as a background thread asynchronously with the request from the application program 4.

A system time sequence number generation module 9 is a software module which generates a unified system time sequence number in a system used by the data management means. The system time sequence number generation module 9 returns a system time sequence number as a monotonously progressed value varied from one inquiry to another. Even when inquiries are made in parallel from a plurality of threads, it is guaranteed that different system time sequence numbers are returned to the threads. The system time sequence number does not have to correspond to real time. A large value not circulated in reality can be stored, and set by using the counter 13 which increments the value for each request. The value may be linked with a clock mounted by hardware.

The application program 4 may independently manage the application data 14 in addition to data managed by the data management means.

A thread that executes the procedure of the application program 4 and a thread that executes the procedure of the data management means may be the same, or different threads operated in cooperation. In the first embodiment of this invention, the application program 4, the object insertion module 5 that is a software module of the data management means, the object deletion module 6, and the object referring module 7 are directly linked with each other, and the software module of the data management means is executed by the same thread as that of the application program 4 which has made a request. However, the object area reclaim module 8 is executed by a thread different from a thread which executes the application program 4.

The object deletion module 6 and the object referring module 7 use a cursor for sequentially referring to objects. All cursors handled by the data management means are stored in the cursor pool 15. The cursors included in the cursor pool 15 are allocated one by one to threads which execute the object deletion module 6 and the object referring module 7. The set stored in the entry heap 10 is scanned by using the allocated cursors.

FIG. 5 is a diagram illustrating a data storage form in the data storage unit 12 according to the first embodiment of this invention.

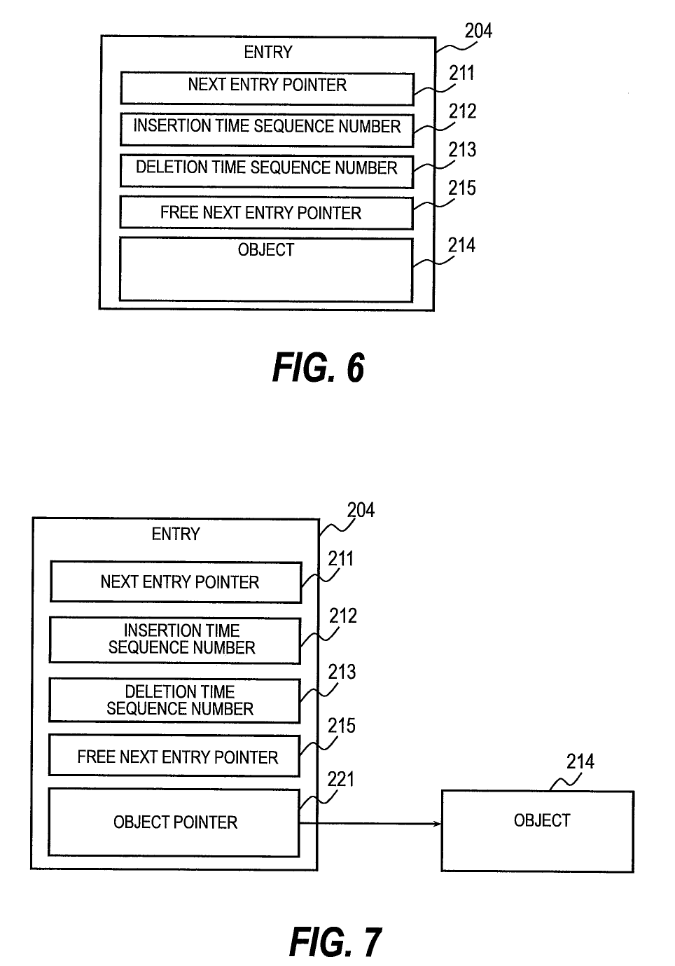

FIG. 6 is a diagram illustrating a configuration example of an entry 204 stored in the data storage unit 12 according to the first embodiment of this invention.

A set of objects 214 is stored in the entry heap 10 in a form of a linked list of entries 204 corresponding to the objects 214 on a one-on-one basis. In the first embodiment of this invention, the objects 214 are stored as parts of the entry 204 to correspond to each other.

A set anchor 201 is a pointer variable for storing an address of a head entry 204 of the linked list corresponding to the set.

As illustrated in FIG. 6, the entry 204 includes a next entry pointer 211, an insertion time sequence number 212, a deletion time sequence number 213, a free next entry pointer 215, and the object 214.

The next entry pointer 211 is a pointer variable for storing an address of a next entry pointer in the linked list corresponding to the set. The insertion time sequence number 212 stores a time sequence number at which the entry 204 has been inserted into the set. The deletion time sequence number 213 stores a time sequence number at which the entry 204 has been deleted from the set. The free next entry pointer 215 is a pointer variable for storing, to link the entry 204 with another released entry 204 when the entry 204 is deleted from the set and then managed as a free area, an address of the another released entry 204. To add a new entry 204 to the set, a free entry is obtained from the free area, a value is set in each member, and the entry is inserted into the linked list corresponding to the set.

The entry 204 constituting the linked list, in other words, the entry 204 having a deletion time sequence number 213 set in response to a deletion request from the application program 4, is referred to as a deleted entry. The deleted entry that includes a value of a deletion time sequence number 213 before a referring time sequence number of the cursor is referred to as an invalid entry in the cursor. On the other hand, the entry 204 constituting the liked list that is not an invalid entry is referred to as a valid entry in the cursor.

In the entry heap 10, an entry 204 and an object 214 not constituting the linked list corresponding to the set coexist. These are an entry 204 and an object 214 where application data is yet to be stored or an object deleted from the set has been separated from the corresponding linked list by the object area reclaim module 8. In the first embodiment of this invention, such an entry 204 and an object 214 are managed in a linked list called a free list. Thus, a free entry 204 and a free object 214 can be efficiently accessed during use or reutilization. The free next entry pointer 215 of the entry 204 is used for referring to a next entry 204 in a case of constituting a free list. A free anchor 202 is an anchor of the linked list for referring to a head entry 204 of the free list.

FIG. 7 is a diagram illustrating another configuration example of the entry 204 stored in the data storage unit 12 according to the first embodiment of this invention.

A next entry pointer 211, an insertion time sequence number 212, a deletion time sequence number 213, and a free next entry pointer 215 are similar to those of the entry illustrated in FIG. 6.

The object 214 is included as the member variable in the entry 204 in the configuration illustrated in FIG. 6. In a configuration illustrated in FIG. 7, however, an area is allocated independently from the entry 204, and the object 214 is referred to by an object pointer 221 which is a member variable of the entry 204. This setting facilitates management of objects varied in size in a programming language such as C or C++. For an area management of the object 214 of FIG. 7, a free list is used as in the same manner of the entry 204. In the first embodiment of this invention, the area management of the object 214 of FIG. 7 is executed in an execution environment of an OS and a programming language, and no description is made to a management procedure.

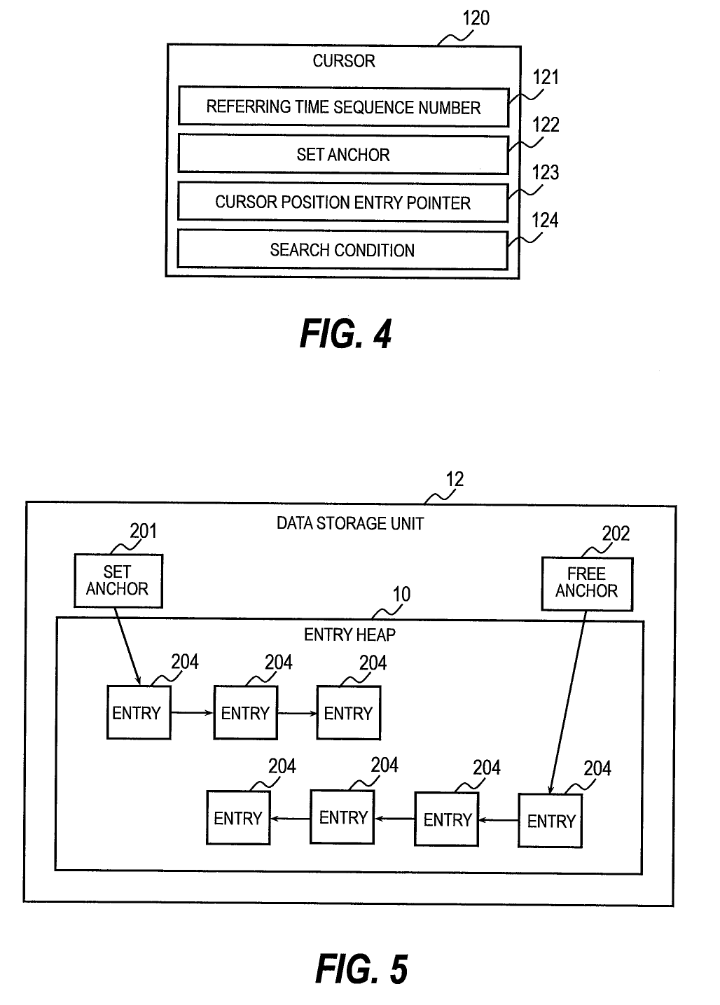

FIG. 4 is a diagram illustrating a configuration of a cursor 120 according to the first embodiment of this invention.

The cursor 120 keeps a state for accessing all the objects 214 in the set without any omission or overlapping. The cursor 120 is also used for designating an object when deleting the object 214 from the set.

The cursor 120 includes a referring time sequence number 121, a set anchor 122, a cursor position entry pointer 123, and a search condition 124.

The referring time sequence number 121 stores a time sequence number for using to the cursor 120. The referring time sequence number 121 is used by object sequential referring means for judging whether the entry 204 is valid or invalid by comparison with the deletion time sequence number 213 of the entry 204.

The set anchor 122 is a pointer variable for storing an address of an entry 204 positioned at a head of a linked list corresponding to the cursor 120. In a case where a single set is processed for each thread, a set anchor 122 only needs to be held for each thread. However, in a case where the data management means supports a plurality of sets, a set anchor 122 for referring to the entry 204 positioned at the head of the linked list of a scanning target has to be held for each cursor.

The cursor position entry pointer 123 is a pointer variable to store an address of an entry 204 included in the linked list corresponding to the set and currently referred to. The search condition 124 is for selectively accessing an object in the set.

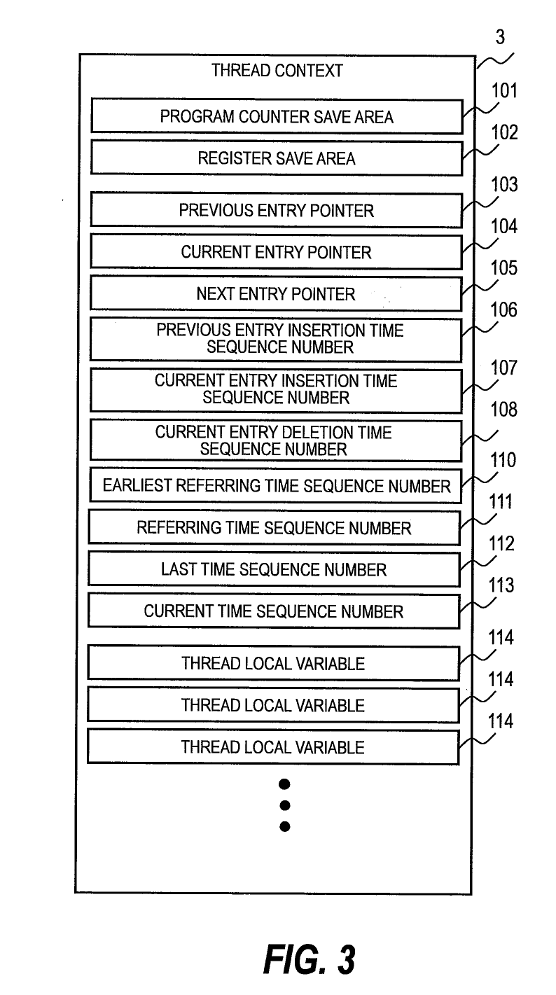

FIG. 3 is a diagram illustrating a configuration example of the thread context 3 according to the first embodiment of this invention.

A program counter save area 101 is for storing step position of an executed program when use time of the processor 21 allocated to the thread expires. Similarly, a register save area 102 is for storing a register of the processor 21 when the use time of the processor 21 expires. Generally, the program counter save area 101 and the register save area 102 are allocated to be managed by the OS.

A previous entry pointer 103, a current entry pointer 104, and a next entry pointer 105 are pointer variables for storing an address of the entry 204. The previous entry pointer 103, the current entry pointer 104, and the next entry pointer 105 are used for scanning the linked list at the time of object sequential referring or object area reclaiming using the cursor 120. Similarly, a previous entry insertion time sequence number 106, a current entry insertion time sequence number 107, and a current entry deletion time sequence number 108 are used for linked list scanning.

An earliest referring time sequence number 110 stores a referring time sequence number 121 of a first-accessed cursor 120 among the cursors 120 stored in the cursor pool 15. The earliest referring time sequence number 110 is used for comparison with the deletion time sequence number 213 of the entry 204 to judge area reclaiming permission of the entry 204 and an object corresponding to the entry in an object area reclaim thread. A referring time sequence number 111 is a temporary variable used for obtaining the earliest referring time sequence number 110.

In addition, a thread local variable 114 exclusively used for each thread is present in the thread context 3.

The previous entry pointer 103, the current entry pointer 104, the next entry pointer 105, the previous entry insertion time sequence number 106, the current entry insertion time sequence number 107, the current entry deletion time sequence number 108, the earliest referring time sequence number 110, and the thread local variable 114 are generally generated in a heap area or a stack area provided based on an execution environment of the OS or the programming language, and managed in association with the program counter save area 101 and the register save area 102.

A procedure of referring to the set according to the first embodiment of this invention will be described below.

In the first embodiment of this invention, as described above, the set that is a collection of objects not guaranteed for an access order is configured as the linked list linearly linking the entry 204 corresponding to the object by a link.

To insert an object into the set, a current time sequence number is set in the insertion time sequence number 212 of the entry 204 corresponding to the object, and the object is then inserted into a head of the linked list. In this way, the entry 204 is linked so that the insertion time sequence number 212 can be set in descending order (from present to past) in the linked list.

To delete an object from the set, a current time sequence number is set in the deletion time sequence number 213 of the corresponding entry, and the entry of the object is then set in a deleted state.

To sequentially refer to the objects in the set by using the cursor, the cursor is traced from its current position to a next entry pointer 211 to scan the linked list. In a case where the entry being scanned is not in a deleted state or a deletion time sequence number attribute is newer compared with a referring time sequence number attribute of a referring thread, the entry is set as a new current position of the cursor to notify the application of access to the object.

To reclaim an area used by the deleted entry for reutilization of an object area, referring time sequence numbers of all referring threads present at the time of reclamation are referred to, and an earliest time sequence number among them is set as an earliest referring time sequence number. Then, the entry is traced from a head of the linked list to a link of a next entry pointer to be scanned. In a case where the entry being scanned has been deleted, and a deletion time sequence number attribute is older compared with the earliest referring time sequence number attribute of the referring thread, the entry is separated from the linked list, and areas of the entry and a corresponding object are targeted for reutilization.

During the sequential referring to the objects in the set by the cursor described above, if the deleted entry is reclaimed at a timing of referring to the deleted object by the cursor entry pointer 104 to be reutilized, a link to a next node in the original linked list is not guaranteed. In this case, judging that an insertion time sequence number attribute of the deletion target object is newer than that of a last entry enables detection of reutilization of an area of the deleted entry. When the reutilization of the area of the deletion target object is detected, the pointer variable is returned to a valid entry where the cursor has been positioned before the sequential referring request to re-execute cursor scanning processing.

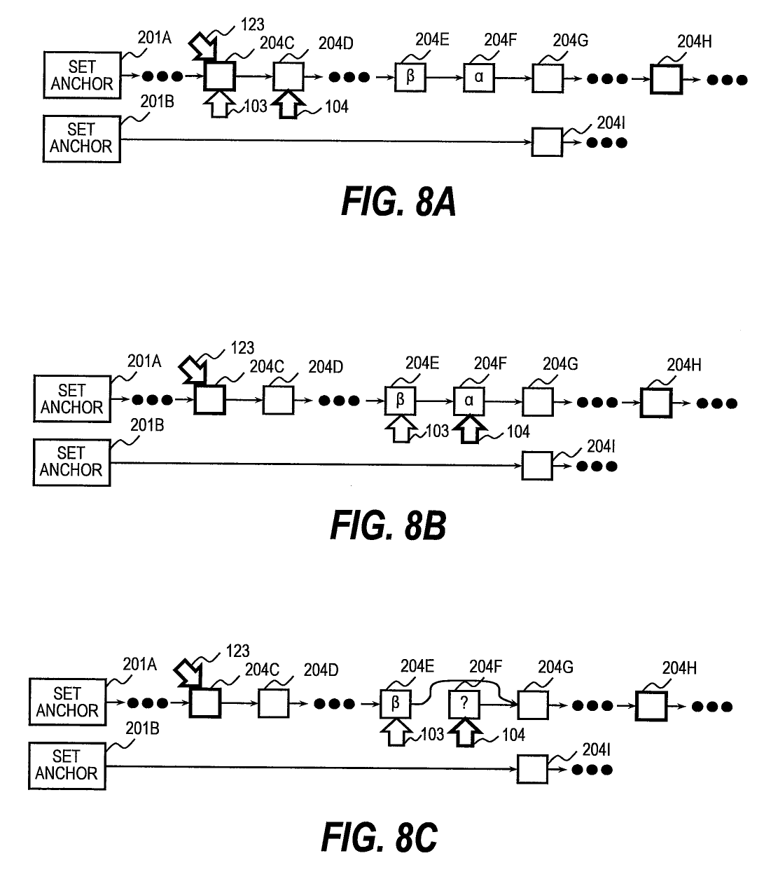

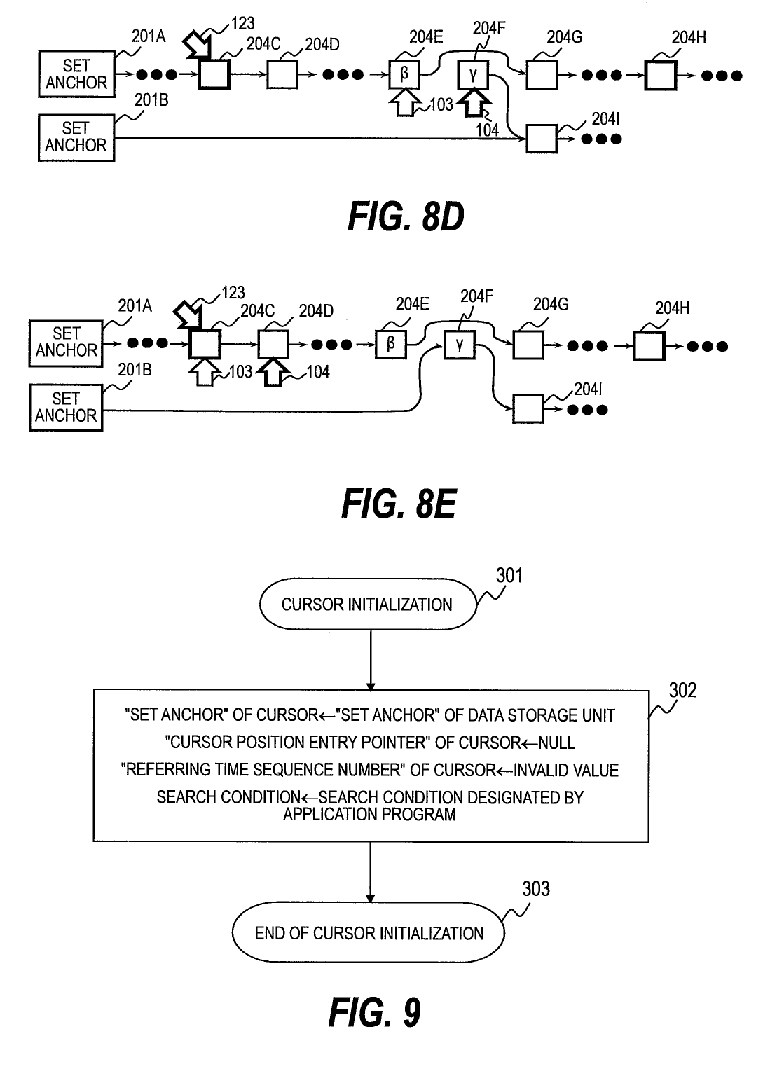

Referring to FIGS. 8A to 8E, the procedure of detecting reutilization of the area of the deleted entry in the sequential referring of objects, and returning the pointer variable to the valid entry where the cursor has been positioned before the sequential referring request to re-execute linked list scanning processing will in a scenario be described in detail below.

FIG. 8A is a diagram illustrating a set which includes a linked list referred to from a set anchor 201A according to the first embodiment of this invention. Upper and lower parts of FIG. 8A are respectively set as “set A” and “set B”.

As described above, the entries 204 are arrayed in descending order of the insertion time sequence numbers 212. For example, a<β is set, where a denotes an insertion time sequence number 212 of an entry 204F, and β denotes an insertion time sequence number 212 of an entry 204E.

The cursor position entry pointer 123 of the cursor 120 currently refers to an entry 204C. An entry to which the cursor moves next is an entry 204H according to an object sequential referring request from the application program 4. Entries 204 between the entries 204C and 204H are deleted as invalid entries inhibited from being referred to from the referring thread which uses the cursor. Areas of the deleted entries may be reclaimed to be used again in a case where they are set as invalid entries referable from none of the threads. On the other hand, the entry 204C where the cursor is currently positioned and the entry 204H next to it are valid entries referable from the thread having the cursor. Thus, these entries 204C and 204H are not area reclaiming and reutilizing targets at least during the period of sequential referring request processing.

In a case where a sequential referring request is received in a state where the cursor position entry pointer 123 of the cursor 120 points to the entry 204C, first, the object referring module 7 sets a value of the cursor position entry pointer 123 of the cursor 120 in the previous entry pointer 103 of the thread context 3, and a value of the next entry pointer 211 of the entry 204C corresponding to the previous entry pointer 103 in the current entry pointer 104.

The object referring module 7 assigns, while the entry 204 corresponding to the current entry pointer 104 of the thread context 3 is invalid, the value of the current entry pointer 104 to the previous entry pointer 103, and the value of the next entry pointer 211 of the entry 204 corresponding to the current entry pointer 104 to the current entry pointer 104 to scan the linked list.

FIG. 8B is a diagram illustrating a state where the object referring module 7 has moved the previous entry pointer 103 of the thread context 3 and the entry corresponding to the current entry pointer 104 according to the first embodiment of this invention.

FIG. 8B illustrates setting of a state where the current entry pointer 104 refers to the entry 204F and the previous entry pointer 103 refers to the entry 204E. In the state of FIG. 8B, an area of the entry 204F is reclaimed by the object area reclaim module 8.

FIG. 8C is a diagram illustrating a case where the object area reclaim module 8 has separated the entry 204F from the linked list corresponding to the cursor 120 according to the first embodiment of this invention.

FIG. 8C illustrates a case where the area of the entry 204F has been reclaimed. In this state, the object area reclaim module 8 sets a pointer of an entry 204G in a next entry pointer 211 of the entry 204E. A next entry pointer 211 of the entry 204F has not necessarily been updated with another value at a point of time when the area of the entry 204F is reclaimed.

When the area of the reclaimed entry 204F is used again, the object insertion module 5 may change a value of the next entry pointer 211 of the entry 204F to point to another entry 204I.

FIG. 8D is a diagram illustrating a case where the entry 204F which has been deleted is used again by the object insertion module 5 to be linked to another entry according to the first embodiment of this invention.

In the state of FIG. 8D, the object referring module 7 cannot reach the entry 204G even when the object referring module 7 refers to the next entry pointer 211 of the entry 204F corresponding to the current entry pointer 104, nor the entry 204H to be reached by the cursor.

In the transition from FIG. 8C to FIG. 8D, changing of the next entry pointer of the entry 204F so as to refer to the entry 204I is a part of a procedure of inserting the entry 204F into the set B constituted by a linked list linked from a set anchor 201B by object insertion module. In this case, as described above, the object insertion module 5 sets a value in an insertion time sequence number 212 of the entry 204F. It is guaranteed that a new insertion time sequence number 212 (γ) added to the entry 204F is newer than the insertion time sequence number 212 (γ) of the entry 204E. Thus, in the thread which sequentially refers to the objects, based on the fact that the insertion time sequence number attribute (γ) of the entry 204F corresponding to the current entry pointer 104 is newer than the insertion time sequence number attribute (β) of the entry 204E corresponding to the previous entry pointer 103, the object referring module 7 can detect that the area of the entry 204F corresponding to the current entry pointer 104 has been used again.

FIG. 8E is a diagram illustrating a state where the object referring module 7 has moved the current entry pointer 104 after detection that the deleted entry 204F has been used again according to the first embodiment of this invention.

Having detected that the area of the entry 204F has been used again, the object referring module 7 re-executes scanning of the linked list by setting the previous entry pointer 103 as a cursor position entry pointer 123 of the cursor 120 and the current entry pointer 104 as a next entry pointer 211 of an entry 204 corresponding to the cursor position entry pointer 123 of the cursor 120. In this way, re-executing list scanning by a number of times equal to the number of invalid nodes present between the entries 204C and 204H at worst enables reaching to the valid entry 204H to be reached next by the cursor.

Processing of the data management method according to the first embodiment of this invention will be described below. An acquisition procedure of system time sequence numbers will be described first before an object insertion procedure, deletion procedure, referring procedure, and object area reclaim procedure.

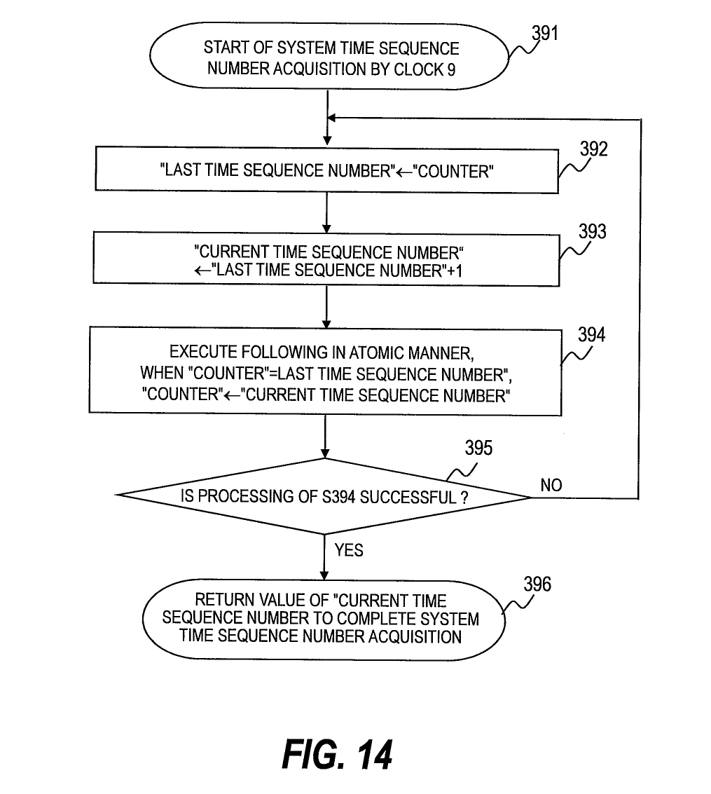

FIG. 14 is a flowchart illustrating the acquisition procedure of system time sequence numbers according to the first embodiment of this invention.

When the acquisition procedure of system time sequence numbers is started (S391), the processor 21 first assigns a value of the counter 13 to a last time sequence number 112 of the thread context 3 (S392). Then, the processor 21 assigns a value obtained by adding 1 to the value of the last time sequence number 112 to a current time sequence number 113 (S393).

The processor 21 executes the following processing as one atomic step not separated by a context switch of a thread by the scheduler or a thread executed by another processor. First, the processor 21 checks whether a value of the counter 13 is equal to that of the last time sequence number 112, in other words, whether the value of the counter 13 has not changed from the processing of Step S392, and second, updates the counter 13 with a value of a current time sequence number 113 in a case where the value has not changed (S394). In a case where the value of the counter 13 is different from that of the last time sequence number 112, the processing of Step S394 is set as a failure without updating the value of the counter 13. The processing of Step S394 is executed in an atomic manner by a processor instruction called a read-modify-write command such as compare-and-swap.

Then, the processor 21 judges whether the read-modify-write command has been successful in Step S394 (S395). In a case where the processing of Step S394 has failed (result of Step S395 is “NO”), the processor 21 executes Step S392 to repeat Steps S392 to S395 until a result is successful.

In a case where the processing of Step S394 has been successful (result of Step S395 is “YES”), the processor 21 returns a value of a current time sequence number variable as a system time sequence number to finish the system time sequence number acquisition procedure (S396).

The procedure of inserting an object into the set will be described below.

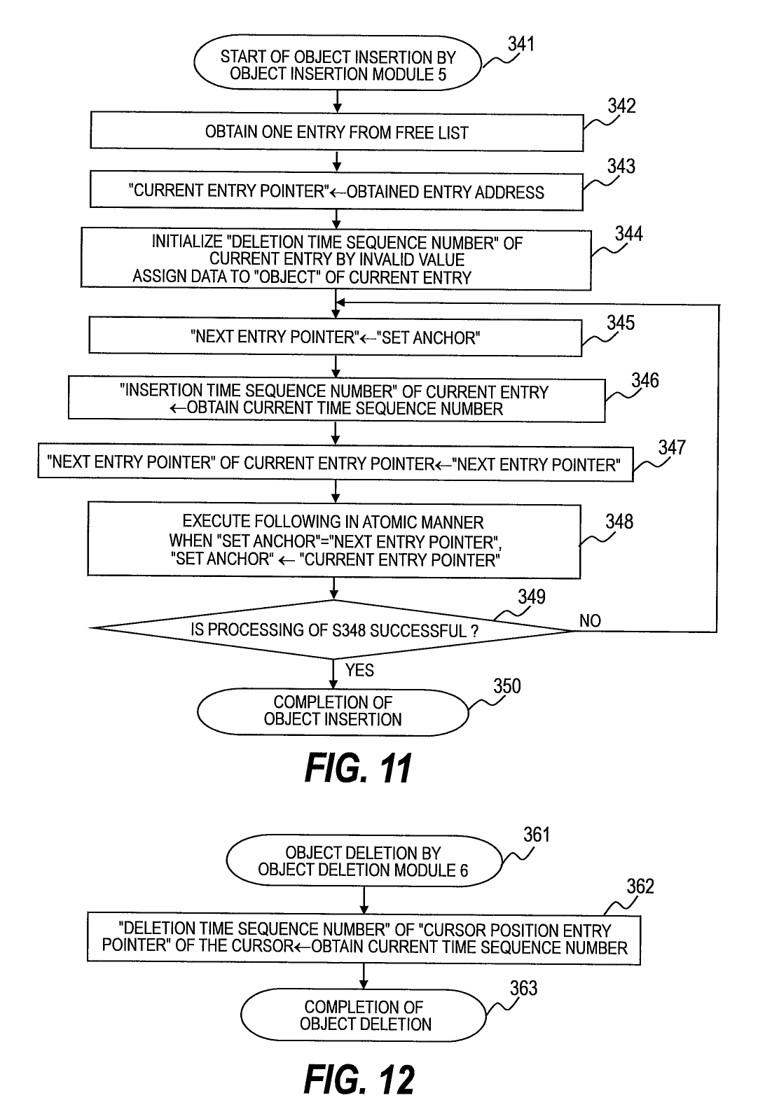

FIG. 11 is a flowchart illustrating a procedure of inserting an object 214 into the set according to the first embodiment of this invention.

In a case of receiving a request of inserting the object 214 into the set from the application program 4, the processor 21 executes the object insertion module 5 which is the data management means to start the object insertion procedure (S341).

The processor 21 first obtains one entry 204 included in the free list from the entry heap (S342). Specifically, the processor 21 obtains an entry 204 corresponding to a free anchor 202. In this case, the processor 21 sets, in the free anchor 202, a free next entry pointer 215 of the entry 204 corresponding to the free anchor 202.

The processor 21 stores an address of the entry 204 obtained from the free list in the current entry pointer 104 of the thread context 3 (S343). The entry 204 obtained from the free list is referred to as a current entry hereinafter. In the first embodiment of this invention, a free area of an object 214 included in the entry 204 is simultaneously secured.

The processor 21 initializes a deletion time sequence number 213 of the current entry with an invalid value, and assigns insertion request data from the application program 4 to the object 214 (S344).

The processor 21 stores a value of the set anchor 201 in a next entry pointer 105 of the thread context 3 (S345). The processor 21 obtains a time sequence number from the system time sequence number generation module 9 to assign the time sequence number to the insertion time sequence number 212 of the current entry (S346). The processor 21 assigns a value of the next entry pointer 105 of the thread context 3 to a next entry pointer 211 of the current entry (S347).

Subsequently, the processor 21 executes the following step as an atomic operation as in the case of the processing of Step S394 of the system time sequence number acquisition of FIG. 14. First, the processor 21 checks whether a value of the set anchor 201 is equal to that of the next entry pointer 105, in other words, whether the value of the set anchor 201 has not changed after the processing of Step S345, and second, to update the set anchor 201 with a value of the current entry pointer (S348).

The processor 21 judges whether the processing of Step S348 has been successful (S349). In a case where the processing of Step S348 has failed (result of Step S349 is “NO”), the processor re-executes Steps S345 to S349 until a successful result is obtained.

In a case where the processing of Step S348 is successful (result of S349 is “YES”), the processor 21 completes the object insertion procedure (S350).

Through the object insertion procedure, the insertion time sequence number 212 of each entry is maintained, in the inked list corresponding to the set, to align from present to past from a head to a tail of the linked list.

The procedure of deleting an object from the set will be described below.

FIG. 12 is a flowchart illustrating a procedure of deleting an object 214 from the set according to the first embodiment of this invention.

In a case where receiving a request of deleting the object 214 from the set from the application program 4, the processor 21 executes the object deletion module 6 which is the data management means to start the object deletion procedure (S361).

The processor 21 first obtains an entry 204 corresponding to an object 214 of a deletion target by the cursor 120. The entry 204 corresponding to the object 214 of the deletion target corresponds to the cursor position entry pointer 123 of the cursor 120 at this time. Then, the processor 21 obtains a current time sequence number from the system time sequence number generation module 9, and assign the current time sequence number to a deletion time sequence number 213 of the obtained entry 204 (S362) to complete the object deletion from the set (S363).

The object 214 of the deletion target and the corresponding entry 204 are actually separated from the linked list corresponding to the set through the object area reclaim procedure executed asynchronously with the object deletion procedure.

The object area reclaim procedure of reclaiming an area of a deleted entry from the linked list corresponding to the set for reutilization will be described below.

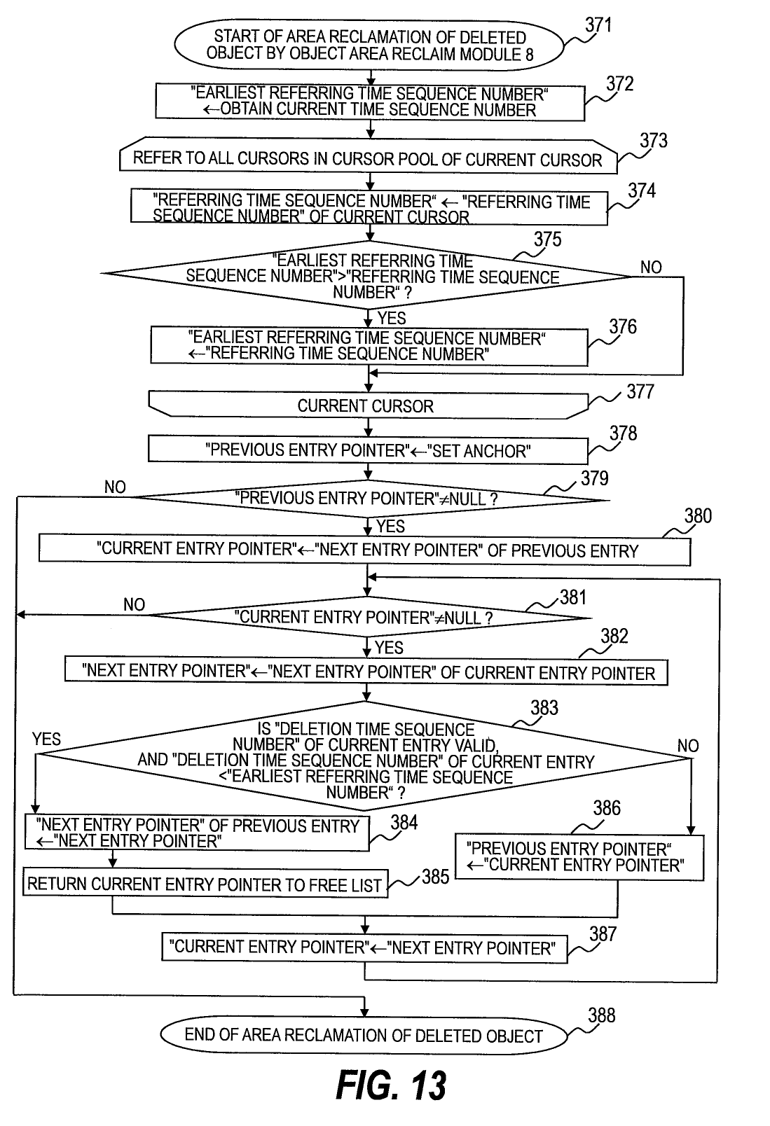

FIG. 13 is a flowchart illustrating the procedure of reclaiming the area of the deleted entry for reutilization according to the first embodiment of this invention.

The processor 21 starts reclaiming of an area of a deleted entry by a certain opportunity (S371). In the first embodiment of this invention, the processing is periodically started by an interval timer using a hardware clock. Other opportunities may be acquisition and monitoring of statistical information regarding a use situation of the element/object heap to exceed a certain boundary condition, and detection of a shortage of free areas when a free object area is secured in object insertion.

The processor 21 initializes an earliest referring time sequence number 110 in the thread context 3 of the object area reclaim thread with the current system time sequence number obtained from the system time sequence number generation module 9 (S372).

Subsequently, the processor 21 executes the following processing to set an earliest referring time sequence number 110 for all the cursors 120 included in the cursor pool 15 (S373). The cursor referred to in the loop is set as a current cursor.

The processor 21 assigns a referring time sequence number 121 of the current cursor to the referring time sequence number 111 of the thread context 3 (S374). Then, the processor 21 judges whether the earliest referring time sequence number 110 is later than the referring time sequence number 111 (S375).

In a case where the earliest referring time sequence number 110 is later than the referring time sequence number 111 (result of S375 is “YES”), the processor 21 assigns a value of the referring time sequence number 111 to the earliest referring time sequence number 110 (S376). In a case where the earliest referring time sequence number 110 is not after the referring time sequence number 111 (result of S375 is “NO”), the processor 21 skips Step S376. The processor 21 finishes a series of operations in the loop (S377) to return to Step S373. Through Steps S373 to S377, at the execution start time of the object area reclaim procedure, a referring time sequence number earliest in all the cursors included in the cursor pool 15 is stored in the earliest referring time sequence number 110.

Subsequently, the processor 21 assigns a value of the set anchor 201 to the previous entry pointer 103 of the thread context 3 (S378). The processor 21 judges whether the value of the previous entry pointer 103 assigned in Step S378 is not “null” (S379). When the value of the previous entry pointer 103 is “null” (result of Step S379 is “NO”), the processor 21 finishes the object area reclaim procedure (S388).

When the value of the previous entry pointer 103 is not “null” (result of S379 is “YES”), the processor 21 assigns a value of a next entry pointer 211 of the entry 204 corresponding to the previous entry pointer 103 to the current entry pointer 104 (S380).

The processor 21 judges whether the value of the current entry pointer 104 assigned in Step S380 is not “null” (S381). In a case where the value of the current entry pointer 104 is “null” (result of Step S381 is “NO”), the processor 21 finishes the object area reclaim procedure (S388). In a case where the value of the current entry pointer 104 is not “null” (result of S381 is “YES”), the processor 21 assigns a value of a next entry pointer 211 of the entry 204 corresponding to the current entry pointer 104 to the next entry pointer 105 (S382).

Then, the processor 21 judges whether a value of the deletion time sequence number 213 of the current entry corresponding to current entry pointer 104 is valid, and whether the deletion time sequence number 213 of the current entry corresponding to the current entry pointer 104 is earlier than the earliest referring time sequence number 110 (S383).

In a case where the value of the deletion time sequence number 213 of the current entry corresponding to the current entry pointer 104 is valid, and the deletion time sequence number 213 of the current entry corresponding to the current entry pointer 104 is earlier than the earliest referring time sequence number 110 (result of S383 is “YES”), the processor 21 assigns a value of the next entry pointer 105 to the next entry pointer 211 of the entry 204 corresponding to the previous entry pointer 103. Through Step S384, the current entry corresponding to the current entry pointer 104 in a deleted state is separated from the linked list. Subsequently, the processor 21 links the current entry corresponding to the current entry pointer 104 separated from the linked list to the free list linked to the free anchor 202.

In a case where the value of the deletion time sequence number 213 of the current entry corresponding to the current entry pointer 104 is in valid, or the deletion time sequence number 213 of the current entry corresponding to the current entry pointer 104 is later than the earliest referring time sequence number 110 (result of S383 is “NO”), the processor 21 assigns a value of the current entry pointer 104 to the previous entry pointer 103 (S386).

After completion of Steps S385 or S386, the processor 21 assigns the value of the next entry pointer 105 to the current entry pointer 104 (S387) to return to Step S381.

It should be noted that, in the first embodiment of this invention, the earliest referring time sequence number is obtained from the cursor included in the cursor pool 15. However, the acquisition is not limited to this. In the object area reclaim thread, by obtaining a referring time sequence number of a referring thread which executes object sequential referring, the processor only needs to confirm that an entry 204 of an area reclaim candidate is invalid for all the referring threads.

Referring to FIG. 9, the initialization procedure of the cursor 120 for sequential reference of objects in the set will be described.

FIG. 9 is a flowchart illustrating the procedure of initializing the cursor 120 for sequential reference of objects in the set according to the first embodiment of this invention.

The processor 21 first allocates a cursor 120 for sequential reference of objects in the set from the cursor pool 15 by the application program 4, and executes the object referring module 7 to initialize the cursor 120. After reception of a cursor initializing request, the processor 21 starts the cursor initialization procedure by the object referring module 7 (S301).

The processor 21 then sets a value of the set anchor 201 which is a head entry of the linked list corresponding to the scanning target set in the set to anchor 122 of the cursor 120. The processor 21 initializes the cursor by setting an invalid address “null” in the cursor position entry pointer 123 and an invalid value in the referring time sequence number 121. In a case where the application program 4 has designated a search condition for selectively referring to an object in the set, the processor 21 sets the designated search condition in the search condition 124 (S302). Thus, the cursor initialization procedure is completed (S303).

Next, a procedure of referring the objects one by one in the set by using the initialized cursor 120 will be described below.

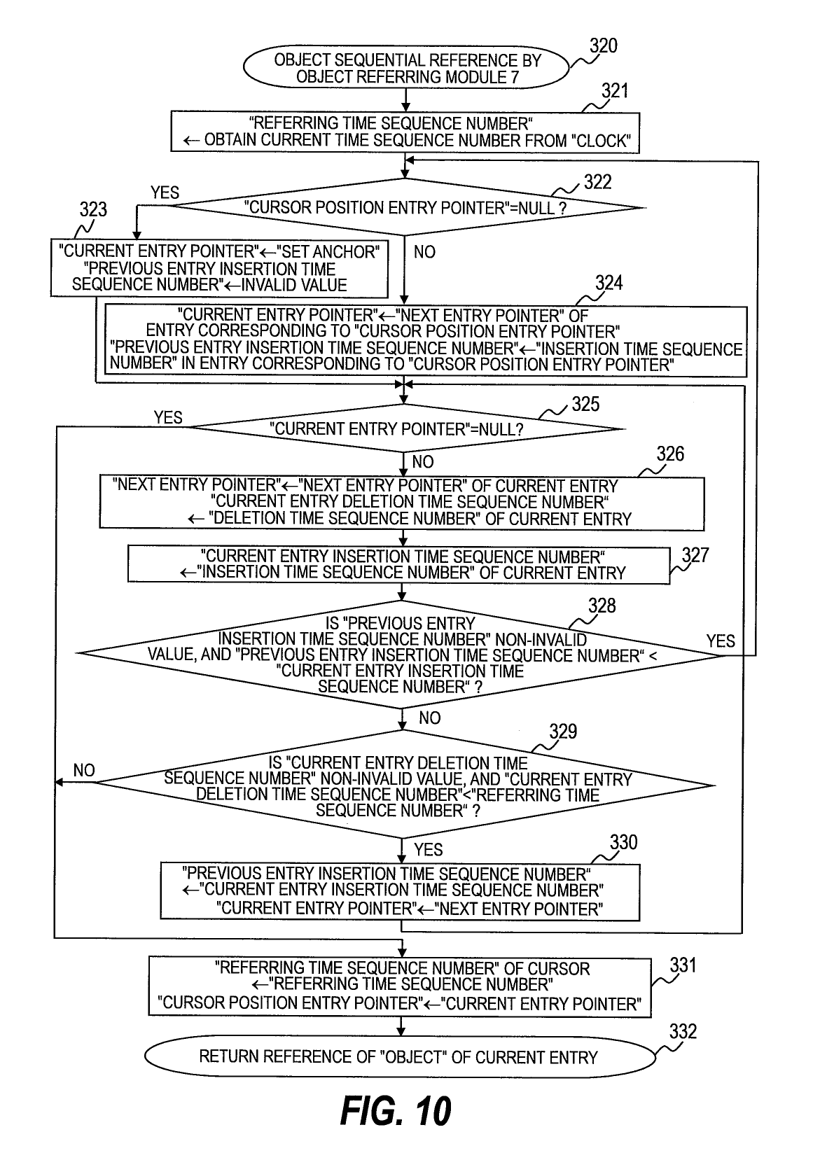

FIG. 10 is a flowchart illustrating the procedure of referring to the objects in the set by the cursor 120 according to the first embodiment of this invention.

After reception of an object sequential referring request from the application program 4, the processor 21 executes the object referring module 7 to start an object sequential referring procedure (S320). The cursor 120 has been initialized before the object sequential referring procedure is called first.

The processor 21 first obtains a system time sequence number from the system time sequence generation module 9, which is then assigned to the referring time sequence number 111 of the thread context 3 (S321). Subsequently, the processor 21 judges whether or not a value of the cursor position entry pointer 123 of the cursor 120 is “null” (S322).

In a case where the value of the cursor position entry pointer 123 of the cursor 120 is “null” (result of S322 is “YES”), the processor 21 assigns a value of the set anchor 122 of the cursor 120 to the current entry pointer 104 of the thread context 3, and an invalid value to the pervious entry insertion time sequence number 106 (S323). In a case where this processing is first executed after the cursor initialization, the processor 21 executes Step S323 because the value of the cursor position entry pointer 123 is “null”.

On the other hand, in a case where the case is not immediately after the cursor initialization, because the value of the cursor position entry pointer 123 is not “null” (result of S322 is “NO”), the processor 21 assigns a value of the next entry pointer 211 of an entry 204 corresponding to the cursor position entry pointer 123 of the cursor 120 to the current entry pointer 104 of the thread context 3. The processor 21 assigns a value of the insertion time sequence number 212 of the entry 204 corresponding to the cursor position entry pointer 123 of the cursor 120 to the previous entry insertion time sequence number 106 (S324).

The processor 21 then judges whether or not a value of the current entry pointer 104 is “null” (S325). In a case where the value of the current entry pointer 104 is “null” (result of S325 is “YES”), the processor 21 updates the referring time sequence number 121 of the cursor 120 with a value of the referring time sequence number 111 which is a time sequence number obtained in S321, and assigns the value of the current entry pointer 104 to the cursor position entry pointer 123 (S331) to finish the object sequential referring procedure (S332).

In a case where the value of the current entry pointer 104 is not “null” (result of S325 is “NO”), the processor 21 assigns a value of the next entry pointer 211 of the entry corresponding to the current entry pointer to the next entry pointer 105 of the thread context 3, and assigns a value of the deletion time sequence number 213 of the entry corresponding to the current entry pointer to the current entry deletion time sequence number 108 (S326).

The processor 21 assigns a value of the insertion time sequence number 212 of the entry corresponding to the current entry pointer to the current entry insertion time sequence number 107 (S327). In Step S327, the processor 21 sets the current entry insertion time sequence number 107 for the purpose of judging whether or not an area of the current entry pointer referred to in S326 has not been reclaimed to be used again. Thus, depending on a platform, the processor 21 may need a special processor instruction called a fence command to prevent changing of an execution order of Steps S326 and S327 caused by optimization during execution.

The processor 21 judges whether or not the previous entry insertion time sequence number 106 is not an invalid value, and the previous entry insertion time sequence number 106 is earlier than the current entry insertion time sequence number 107 (S328). In a case where the previous entry insertion time sequence number 106 is not an invalid value, and the previous entry insertion time sequence number 106 is earlier than the current entry insertion time sequence number 107 (result of S328 is “YES”), this means that the current entry has been separated from the corresponding liked list to be used again. Thus, the processor 21 returns to Step S322 to scan the linked list again from the entry before the cursor movement.

In a case where the previous entry insertion time sequence number 106 is the invalid value or is later than the current entry insertion time sequence number 107 (result of S328 is “NO”), the processor 21 judges whether or not the current entry deletion time sequence number 108 is not the invalid value, and is earlier than the referring time sequence number 111 (S329).

In a case where the current entry deletion time sequence number 108 is not the invalid value, and is earlier than the referring time sequence number 111 (result of S329 is “YES”), the current entry is an invalid entry inhibited from being referred to from the cursor because the object has been deleted. Thus, the processor 21 assigns a value of the current entry insertion time sequence number 107 to the previous entry insertion time sequence number 106, inserts a value of the next entry pointer 105 into the current entry pointer 104 (S330), and executes processing of S325 and after.

In a case where the current entry deletion time sequence number 108 is the invalid value or is not earlier than the referring time sequence number 111 (result of S329 is “NO”), the current entry pointer becomes the cursor position entry pointer 123 of the cursor 120. In this case, the processor 21 updates the referring time sequence number 121 of the cursor 120 with a value of the referring time sequence number 111 which is a time sequence number obtained in S321 (S331). The processor 21 returns reference to the object 214 of the entry corresponding to the current entry pointer to the application program 4 to finish the object sequential referring procedure (S332).

It should be noted that, in the first embodiment of this invention, the referring time sequence number 121 of the cursor 120 is updated for each object sequential referring request. However, the referring time sequence number 121 may be updated only once during cursor initialization. In this case, entries 204 corresponding to objects 214 deleted after the initialization of the cursor 120 all become valid objects in the cursor 120.

According to the first embodiment of this invention, in the object sequential reference using the cursor, acquisition of a mutually exclusive lock, execution of an atomic read-modify-write instruction, and acquisition of thread state history are not necessary. Thus, processing costs for referring to the objects can be made low, and high response performance can be obtained.

According to the first embodiment of this invention, to reclaim an area used by a deleted entry, checking of mutually exclusive lock or state history of other threads is not necessary. Thus, processing costs for object reclamation can be made low. The object sequential reference using the cursor does not block area reclamation of the deleted entry or parallel execution of reutilization. Thus, memory use efficiency can be made high.

According to the first embodiment of this invention, object deletion, area reclamation of the deleted entry, and reutilization do not block parallel execution of object sequential reference using the cursor. Thus, high throughput of a referring application can be obtained.

According to the first embodiment of this invention, in object sequential reference using the cursor, any mutually exclusive lock which causes a loss of simultaneous executability of threads is not obtained. Thus, in a multithread environment, a high throughput of the referring application can be obtained.

According to the first embodiment of this invention, in object sequential reference using the cursor, any atomic read-modify-write instruction which causes a loss of simultaneous executability of processors occupying a system bus of a shared-memory type multiprocessor (including multi-core processor) computer system is not carried out. Thus, processor core use efficiency can be improved, and high throughput of the referring application can be obtained.

### Second Embodiment

A second embodiment of this invention is directed to a system where simultaneous execution control of transactions is carried out based on multi-version concurrent control (MVCC).

A transaction is a unit where a series of reference, insertion, updating and deletion operations are carried out with consistency for a data group in an application program. In the MVCC, on the premise that data insertion, updating and deletion are carried out with consistency in a transaction, other transactions that refer to the data can refer to a latest collection of data at the time of starting the transaction where insertion, updating and deletion have been set. Thus, in the case of updating or deleting an object in the MVCC, an old version before updating or deletion is kept separately from a new version after updating or deletion until there is no more possibility that the transaction will refer to the old version.

Contents of the second embodiment of this invention similar to those of the first embodiment of this invention will be omitted from description as occasion demands. For example, the hardware module, the software module, and a relationship therebetween illustrated in FIG. 2 are similar in the second embodiment of this invention.

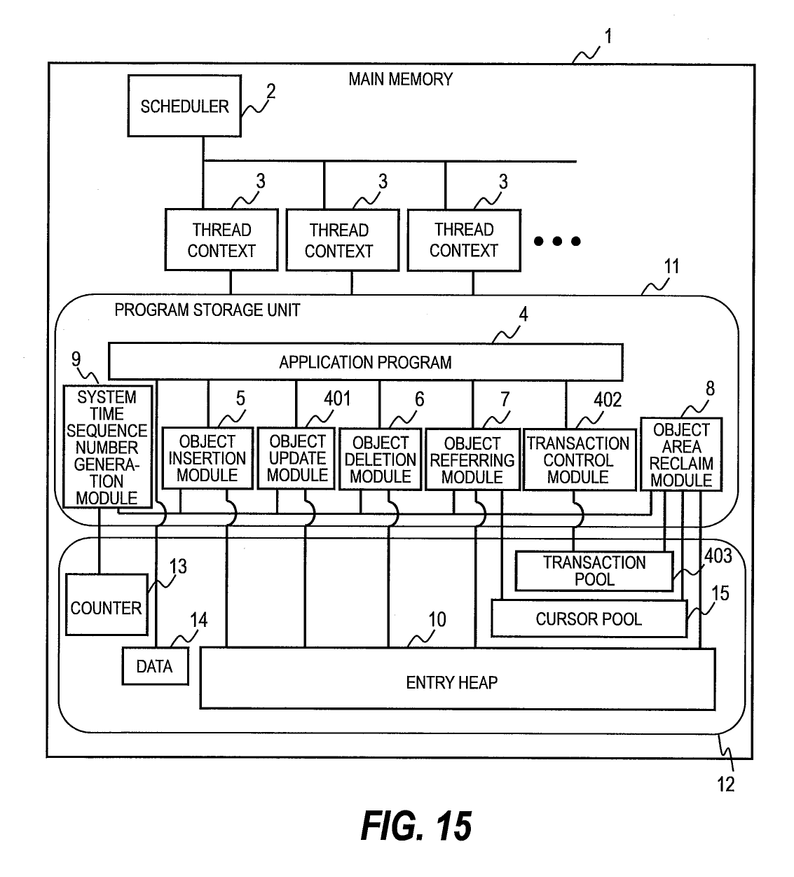

FIG. 15 is a diagram illustrating a configuration of software modules in a data management system according to the second embodiment of this invention.

An application program 4, an object insertion module 5, an object deletion module 6, an object referring module 7, an object area reclaim module 8, a system time sequence number generation module 9, an entry heap 10, a program storage unit 11, a data storage unit 12, a counter 13, application data 14, and a cursor pool 15 are similar to those of the first embodiment of this invention illustrated in FIG. 1.

In the second embodiment of this invention, in addition to the software module components of the first embodiment of this invention, an object update module 401, a transaction control module 402, and a transaction pool 403 are included.

The object update module 401 is a software module for receiving a request from the application program 4 to execute a procedure for updating an object corresponding to a cursor position entry pointer 123 of a cursor 120 in the entry heap 10.

The transaction control module 402 is a software module for receiving a request from the application program 4 to execute a procedure for controlling a start and an end of a transaction.

The transaction pool 403 is an area for managing a transaction management block which keeps a transaction state. The transaction pool 403 stores all transaction management blocks regarding all transactions which access data management means.

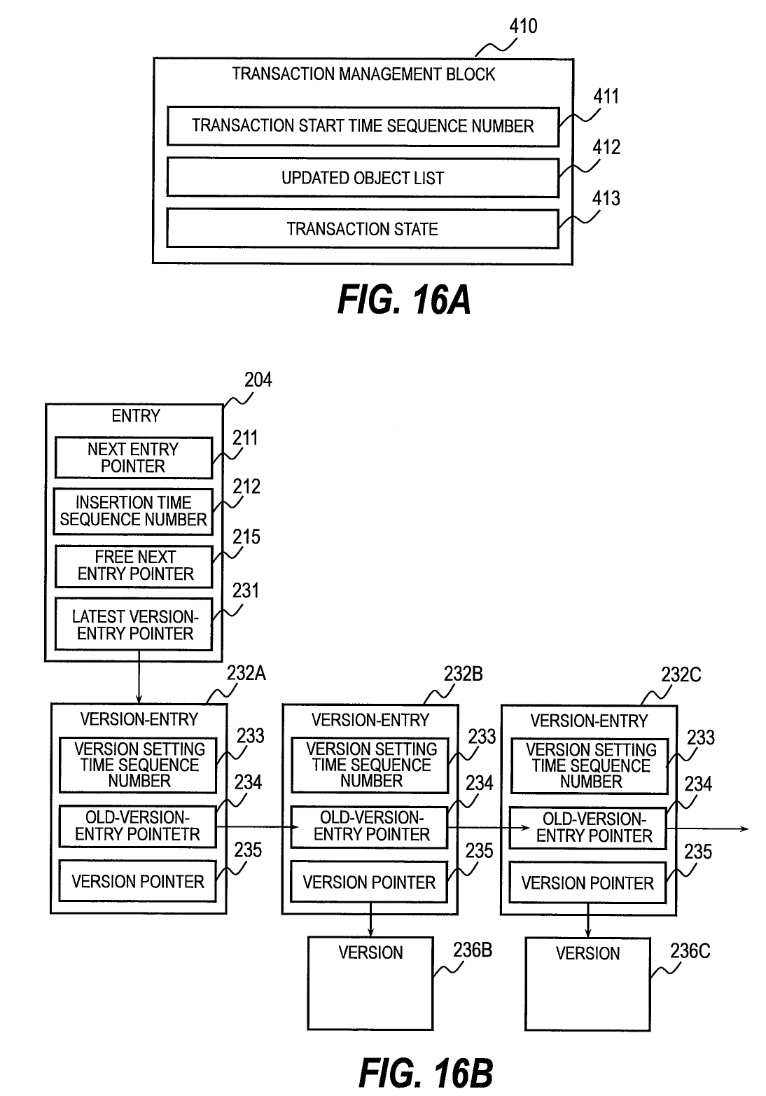

FIG. 16A is a diagram illustrating a configuration example of a transaction management block 410 managed in the transaction pool 403 according to the second embodiment of this invention.

A transaction start time sequence number 411 stores a system time sequence number of the time of starting a transaction.

An update object list 412 stores a list of objects inserted, updated or deleted in the transaction. Specifically, a form of storing addresses of entries 204 corresponding to the objects inserted, updated or deleted in the transaction in a linked list is assumed. However, another method of storing a set of objects such as an array of pointer variables in an entry 204 may be employed.

Further, the transaction management block 410 may include a transaction state 413.

FIG. 16B is a diagram illustrating a configuration example of an entry 204 stored in the data storage unit 12 according to the second embodiment of this invention.

In the second embodiment of this invention, the entry 204 includes one or a plurality of versions 236 and one or a plurality of version-entries 232.

For each entry 204, a next entry pointer 211, an insertion time sequence number 212, and a free next entry pointer 215 are similar to those of the first embodiment of this invention illustrated in FIG. 6. In the second embodiment of this invention, a latest version-entry pointer 231 is added to the member variables of the entry 204. The latest version-entry pointer 231 is a pointer variable for storing an address of a version-entry 232 corresponding to a latest version.

One version-entry 232 is generated during object insertion, and added for each object updating. The version-entry 232 includes a version setting time sequence number 233, an old-version-entry 234, and a version pointer 235 as member variables.

The version 236 is referred to by a version pointer 235 of a corresponding version-entry 232. In other words, the version pointer 235 is a pointer variable for storing an address of the corresponding version 236.

The version-entry 232 constitutes a linked list linked by the old-version-entry 234 in descending order of values of the version setting time sequence numbers 233 with the latest version-entry pointer 231 of the entry 204 set as an anchor. The old-version-entry 234 is a pointer variable for storing an address of the version-entry 232 corresponding not to the latest version but to the old version. During object deletion, a version-entry 232 indicating deletion having no corresponding version is added to a head of the linked list.

The version setting time sequence number 233 is a system time sequence number at the time of committing a transaction which has executed insertion, updating and deletion. A version setting time sequence number 233 of a version-entry 232 indicating deletion which does not refer to the version 236 becomes a deletion time sequence number of the corresponding entry 204.

In the example of FIG. 16B, first, an object is inserted into a set by a value of a version 236C corresponding to a version-entry 232C. Then, the object is updated by a value of a version 236B corresponding to a version-entry 232B. Since a version-entry 232A does not refer to a version 236, the version has been deleted at the end.

A data storage form in the data storage unit 12 of the data management means is similar to that of the first embodiment of this invention illustrated in FIG. 5.

An entry which is a deleted entry, and has a deletion time sequence number earlier than a transaction start time sequence number of a referring transaction is set as an invalid entry in the transaction. On the other hand, an entry 204 that constitutes the linked list but that is not an invalid entry is set as a valid entry in the transaction.

In the entry heap 203, entries 204 that do not constitute the linked list corresponding to the set coexist. In the second embodiment of this invention, as in the case of the first embodiment of this invention, the entries 204 that do not constitute the linked list corresponding to the set are managed by a linked list called a free list.

For the version-entry 232 and the version 236, areas are generally managed by a free list similar to that of the entry 204. In the second embodiment of this invention, however, area management of the version-entry 232 and the version 236 are executed in an OS and programming language execution environment, and will not be described in detail.

Configurations of the cursor 120 and a thread context 3 of the second embodiment of this invention are similar to those of the first embodiment of this invention illustrated in FIGS. 3 and 4.

Processing of a data management method of the second embodiment of this invention will be described below.

A procedure of obtaining a system time sequence number is similar to that of the first embodiment of this invention illustrated in FIG. 14.

Next, a procedure of starting a transaction will be described below.

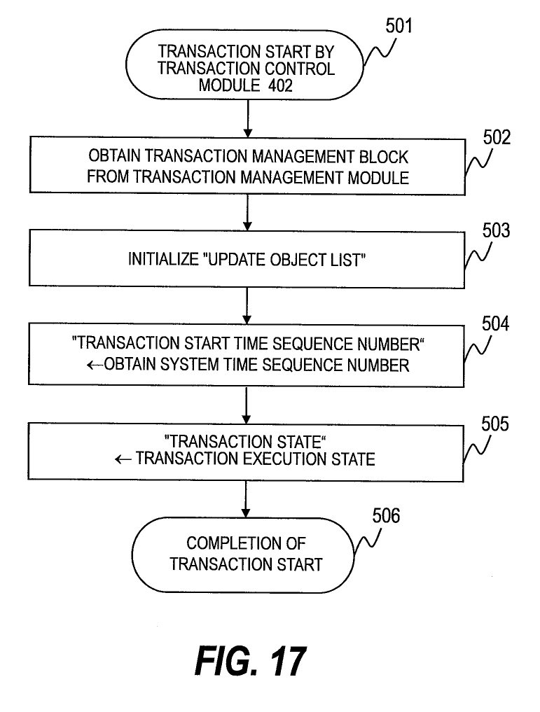

FIG. 17 is a flowchart illustrating the procedure of starting a transaction according to the second embodiment of this invention.

After reception of a transaction start request from the application program 4, the processor 21 executes the transaction control module 402 to start the transaction start procedure (S501).

The processor 21 first obtains a transaction management block 410 from the transaction pool 403 (S502). Then, the processor 21 initializes the update object list 412 of the obtained transaction management block 410 (S503).

The processor 21 obtains a system time sequence number from the system time sequence number generation module 9 to assign it to the transaction start time sequence number 411 (S504). Next, the processor 21 sets the transaction state 413 to a transaction execution state (S505) to finish the transaction start procedure (S506).

A procedure of finishing a transaction will be described below.

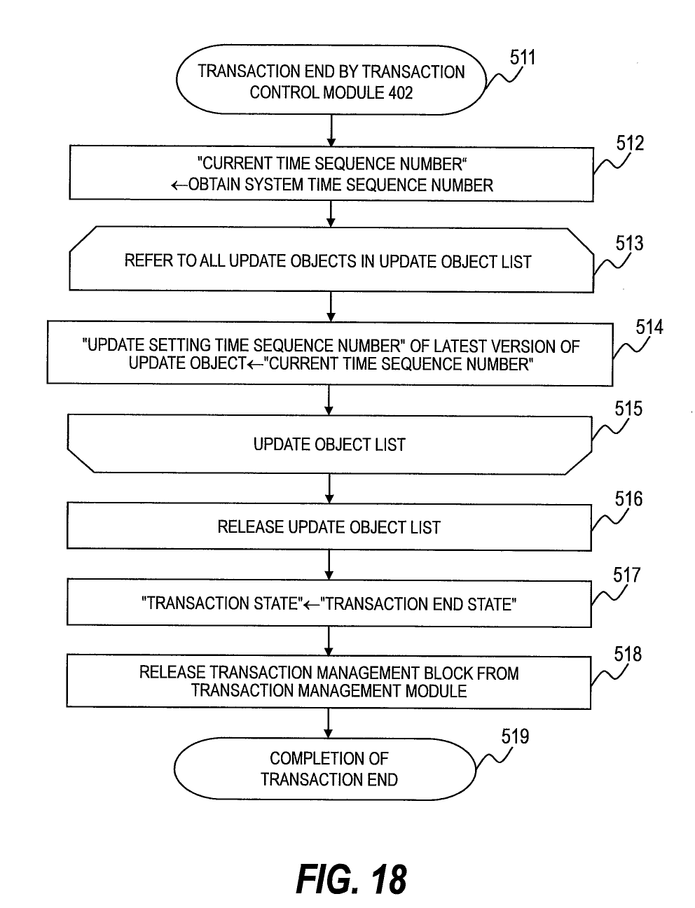

FIG. 18 is a flowchart illustrating the procedure of finishing a transaction according to the second embodiment of this invention.

After reception of a transaction end request from the application program 4, the processor 21 executes the transaction control module 402 to start the transaction end procedure (S511).

The processor 21 first obtains a system time sequence number from the system time sequence number generation module 9 to store it in the current time sequence number 113. Subsequently, the processor 21 executes a loop for updating update setting time sequence numbers of entries 204 corresponding to all the objects included in the update object list (S513). The update setting time sequence number of the entry 204 corresponds to the version setting time sequence number 233 of the latest version-entry of the entry 204. The processor 21 assigns a value of the current time sequence number 133 to the version setting time sequence number 233 of the latest version-entry 232 corresponding to the latest version-entry pointer 231 from the entry 204 corresponding to each object (S514) to return to the head of the loop (S515).

After completion of updating the update setting time sequence numbers of the entries 204 corresponding to all the objects included in the update object list 412, the processor 21 releases the entries 204 included in the update object list 412 (S516). The processor 21 further changes the transaction state 413 to a transaction end state (S517). Lastly, the processor 21 releases the transaction management block 410 (S518) to complete the transaction end procedure (S519).

The procedure of inserting an object into the set will be described below.

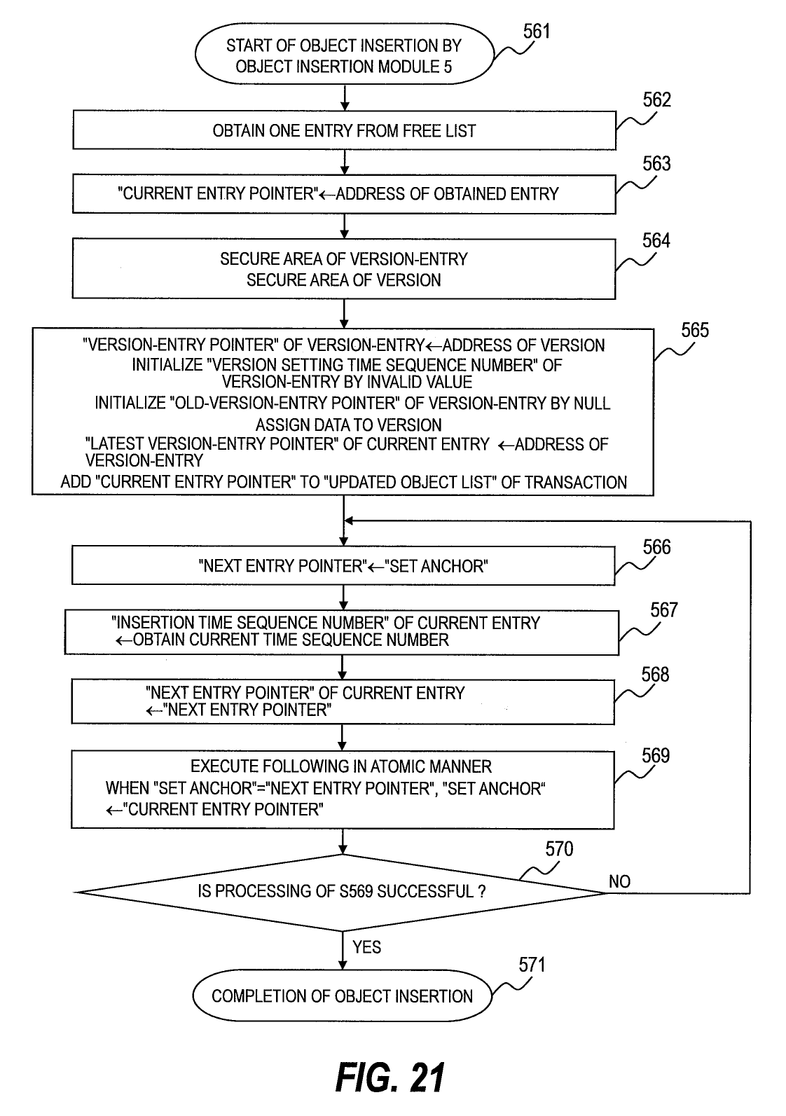

FIG. 21 is a flowchart illustrating a procedure of inserting an object 214 into the set according to the second embodiment of this invention.

In a case where receiving a request of inserting the object 214 into the set from the application program 4, the processor 21 executes the object insertion module 5 which is the data management means to start the object insertion procedure (S561).

The processor 21 first obtains one entry 204 included in the free list from the entry heap (S562). Specifically, the processor 21 obtains an entry 204 corresponding to a free anchor 202. In this case, the processor 21 sets, in the free anchor 202, a free next entry pointer 215 of the entry 204 corresponding to the free anchor 202.

The processor 21 stores an address of the entry 204 obtained from the free list in the current entry pointer 104 of the thread context 3 (S563). The entry 204 obtained from the free list is set as a current entry hereinafter. The processor 21 allocates areas of the version-entry 232 and the version 236 to the entry heap 10 by the OS (S564).

Subsequently, the processor 21 initializes the obtained version-entry 232. Specifically, the processor 21 assigns an address of the version 236 to the version pointer 235 of the version-entry 232. The processor 21 further initializes the version setting time sequence number 233 with the invalid value, and the old-version-entry with “null”. The processor 21 assigns insertion request data from the application program 4 to the version 236, and assigns an address of the version-entry 232 to the latest version-entry pointer 231 of the current entry. Lastly, the processor 21 adds the current entry pointer to the linked list corresponding to the update object list 412 of the transaction management block 410 (S565).

The processor 21 stores a value of the set anchor 201 in a next entry pointer 105 of the thread context 3 (S566). The processor 21 obtains a time sequence number from the system time sequence number generation module 9 to assign the time sequence number to the insertion time sequence number 212 of the current entry (S567). The processor 21 assigns a value of the next entry pointer 105 of the thread context 3 to a next entry pointer 211 of the current entry (S568).

Subsequently, the processor 21 executes the following step as an atomic operation as in the case of the processing of Step S394 of the system time sequence number acquisition. First, the processor 21 checks whether a value of the set anchor 201 is equal to that of the next entry pointer 105, in other words, whether the value of the set anchor 201 has not changed after the processing of Step S345 to update the set anchor 201 with an address of the current entry pointer (S569).

The processor 21 judges whether the processing of Step S569 has been successful (S570). In a case where the processing of Step S569 has failed (result of Step S570 is “NO”), the processor re-executes Steps S566 to S570 until a successful result is obtained.

In a case where the processing of Step S569 is successful (result of S570 is “YES”), the processor 21 completes the object insertion procedure (S571).

Through the object insertion procedure, the insertion time sequence number 212 of each entry is maintained, in the inked list corresponding to the set, to change from present to past from a head to a tail of the linked list.

The procedure of updating an object will be described below.

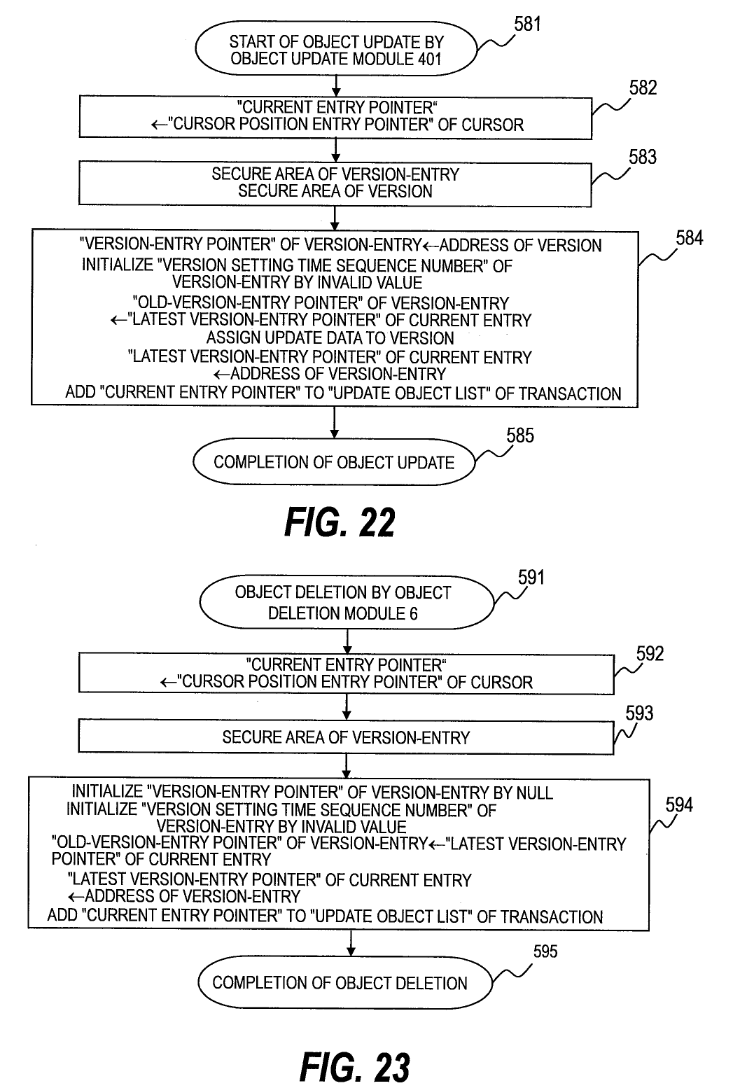

FIG. 22 is a flowchart illustrating a procedure of updating an object according to the second embodiment of this invention.

In a case where receiving a request of updating the object contained in the set from the application program 4, the processor 21 executes the object insertion module 401 which is a data management module to start the object update procedure (S581).

The processor 21 first stores a value of the cursor position entry pointer 123 of the cursor 120 in the current entry pointer 104 of the thread context 3 (S582). Hereinafter, the entry 204 corresponding to the current entry pointer 104 is set as a current entry.

The processor 21 allocates areas of the version-entry 232 and the version 236 to the entry heap 10 by the OS (S583). Subsequently, the processor 21 assigns an address of the version 236 to the version pointer 235 of the version-entry 232 and initializes the version setting time sequence number 233 with the invalid value. The processor 21 assigns a value of the latest entry pointer 231 of the current entry to the old-version-entry 234, and assigns update request data from the application program 4 to the version 236. The processor 21 assigns an address of the version-entry 232 to the latest entry pointer 231 of the current entry. Lastly, the processor 21 adds the current entry to the linked list corresponding to the update object list 412 of the transaction management block 410 (S584) to complete the object update procedure.

The procedure of deleting an object from the set will be described below.

FIG. 23 is a flowchart illustrating a procedure of deleting an object 214 from the set according to the second embodiment of this invention.

The processor 21 executes the object deletion module 6 of the data management module in response to a request of deleting an object from a set from the application program 4 to start the object deletion procedure (S591).

The processor 21 first obtains an entry 204 corresponding to a deletion target object 214 by the cursor 120. The entry 204 corresponding to the deletion target object 214 corresponds to the cursor position entry pointer 123 of the cursor 120. The obtained entry is set as a current entry hereinafter.

The processor 21 assigns the current entry pointer 104 of the thread context 3 to an address of the current entry (S592). Next, the processor 21 allocates an area of the version-entry 232 to the entry heap 10 by the OS (S593).

Subsequently, the processor 21 initializes the version pointer 235 of the version-entry 232 with “null”, and initializes the version setting time sequence number 233 with the invalid value. The processor 21 assigns the latest version-entry pointer 231 of the current entry to the old-version-entry 234, and assigns an address of the version-entry 232 to the latest version-entry pointer 231 of the current entry. Lastly, the processor 21 adds the current entry to the linked list corresponding to the update object list 412 of the transaction management block 410 (S594) to complete deletion of the object from the set (S595).

The deletion target object 214 and the corresponding entry 204 are actually separated from the linked list corresponding to the set by an object area reclaim procedure executed asynchronously with the object deletion procedure.

The object area reclaim procedure for reclaiming an area of deleted entry from the linked list corresponding to the set for reutilization will be described next.

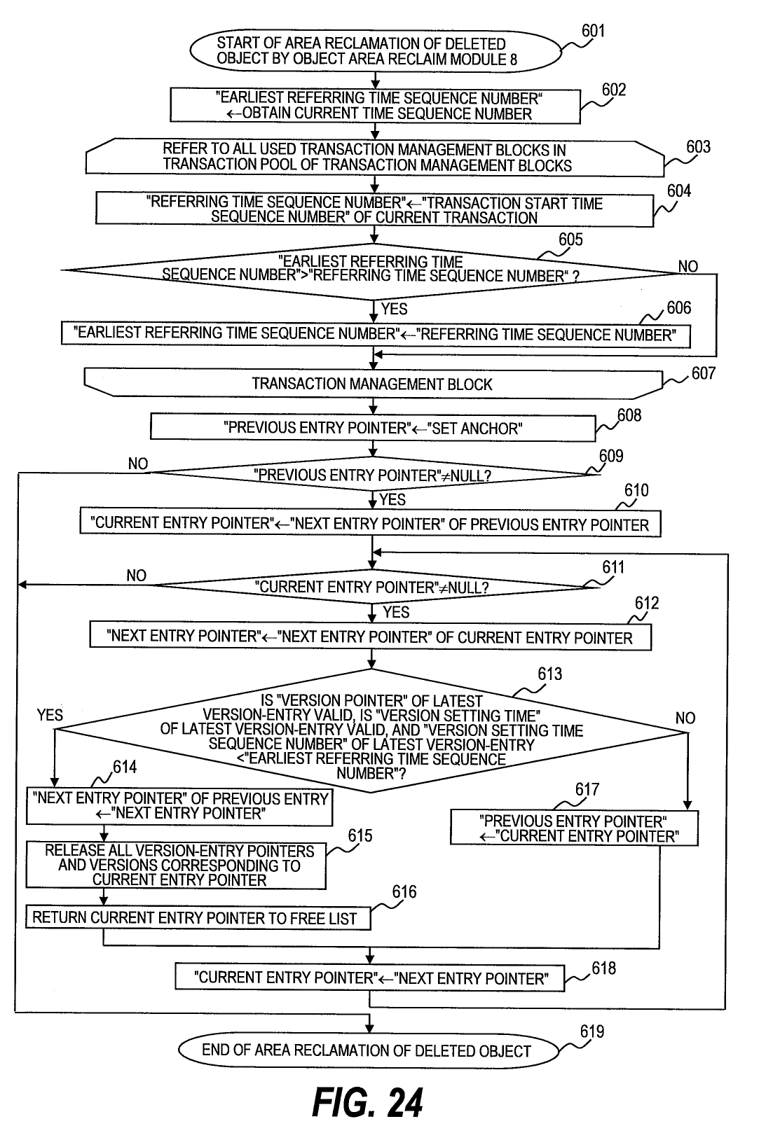

FIG. 24 is a flowchart illustrating the procedure of reclaiming the area of the deleted entry for reutilization according to the second embodiment of this invention.

The processor 21 periodically starts reclaiming of an area of a deleted entry by an interval timer using a hardware clock (S601).

The processor 21 initializes an earliest referring time sequence number 110 in the thread context 3 of the object area reclaim thread with the current system time sequence number obtained from the system time sequence number generation module 9 (S602).

Subsequently, the processor 21 executes the following processing to set an earliest referring time sequence number 110 for all the transaction management blocks 410 being used and included in the transaction pool 403 (S603). The transaction management block 410 referred to in the loop is set as a current transaction hereinafter.

The processor 21 assigns a transaction start time sequence number 411 of the current transaction to the referring time sequence number 111 of the thread context 3 (S604). Then, the processor 21 judges whether the earliest referring time sequence number 110 is later than the referring time sequence number 111 (S605).

In a case where the earliest referring time sequence number 110 is later than the referring time sequence number 111 (result of S605 is “YES”), the processor 21 assigns a value of the referring time sequence number 111 to the earliest referring time sequence number 110 (S606). In a case where the earliest referring time sequence number 110 is not after the referring time sequence number 111 (result of S605 is “NO”), the processor 21 skips Step S606. The processor 21 finishes a series of operations in the loop (S607) to return to Step S603. Through Steps S603 to S607, at the execution start time of the object area reclaim procedure, a transaction start time sequence number earliest in all the transactions included in the transaction pool 403 is stored in the earliest referring time sequence number 110.

Subsequently, the processor 21 assigns a value of the set anchor 201 to the previous entry pointer 103 of the thread context 3 (S608). The processor 21 judges whether the value of the previous entry pointer 103 assigned in Step S378 is not “null” (S609). In a case where the value of the previous entry pointer 103 is “null” (result of Step S609 is “NO”), the processor 21 finishes the object area reclaim procedure (S619).

In a case where the value of the previous entry pointer 103 is not “null” (result of S609 is “YES”), the processor 21 assigns a value of a next entry pointer 211 of the entry 204 corresponding to the previous entry pointer 103 to the current entry pointer 104 (S610).

The processor 21 judges whether the value of the current entry pointer 104 assigned in Step S380 is not “null” (S611). In a case where the value of the current entry pointer 104 is “null” (result of Step S611 is “NO”), the processor 21 finishes the object area reclaim procedure (S619). In a case where the value of the current entry pointer 104 is not “null” (result of S611 is “YES”), the processor 21 assigns a value of a next entry pointer 211 of the entry 204 corresponding to the current entry pointer 104 to the next entry pointer 105 (S612).

The processor 21 judges whether a value of the version pointer 235 of the version-entry 232 (hereinafter, referred to as current latest version-entry) corresponding to the latest version-entry pointer 231 of the entry 204 corresponding to the current entry pointer 104 is “null”, whether a value of the version setting time sequence number 233 of the current latest version-entry is valid, and whether the version setting time sequence number 233 of the current latest version-entry is earlier than the earliest referring time sequence number 110 (S613).

In a case where the conditions of S613 are established (result of S613 is “YES”), the processor 21 assigns a value of a next entry pointer 105 to a next entry pointer 211 of the entry 204 corresponding to the previous entry pointer 103 (S614). Through the processing of S614, the current entry corresponding to the current entry pointer 104 that has been deleted is separated from the linked list.

The processor 21 releases all the version-entries 232 and the version 236 corresponding to the current entry pointer 104 (S615). Subsequently, the processor 21 links the current entry corresponding to the current entry pointer 104 separated from the linked list to a free list to be linked to the free anchor 202 (S616).

In a case where the conditions of S613 are not established (result of S613 is “NO”), the processor 21 assigns a value of the current entry pointer 104 to the previous entry pointer 103 (S617).

After completion of Steps S616 or S617, the processor 21 assigns the value of the next entry pointer 105 to the current entry pointer 104 (S618) to return to Step S611.

The initialization procedure of the cursor 120 to sequentially refer to the objects in the set is similar to that of the first embodiment, and is illustrated in FIG. 9.

A procedure of referring to the objects in the set one by one by using the initialized cursor 120 will be described below.

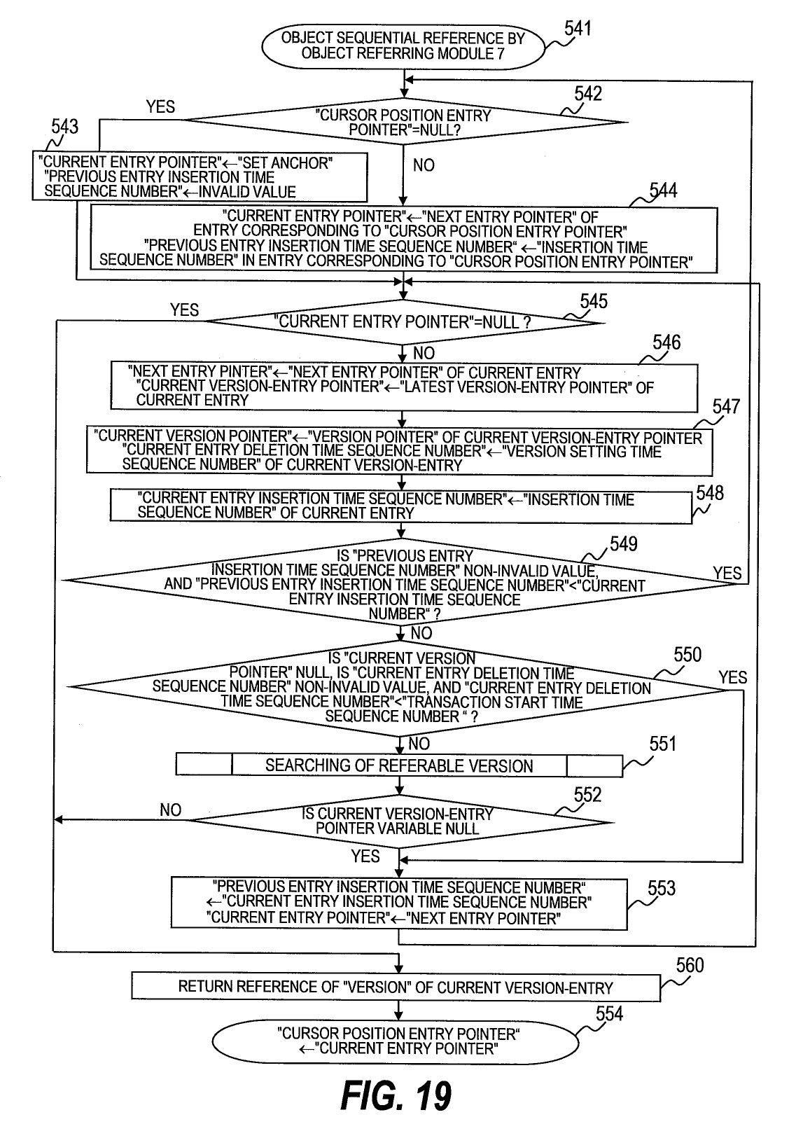

FIG. 19 is a flowchart illustrating the procedure of referring to the objects in the set by the cursor 120 according to the second embodiment of this invention.

After reception of an object sequential referring request from the application program 4, the processor 21 executes the object referring module 7 to start an object sequential referring procedure (S541). The cursor 120 has been initialized before the object sequential referring procedure is called first.

The processor 21 first judges whether or not a value of the cursor position entry pointer 123 of the cursor 120 is “null” (S542).

In a case where the value of the cursor position entry pointer 120 of the cursor 123 is “null” (result of S542 is “YES”), the processor 21 assigns a value of the set anchor 122 of the cursor 120 to the current entry pointer 104 of the thread context 3, and a pervious entry insertion time sequence number 106 with the invalid value (S543). In a case where this processing is first executed after the cursor initialization, the processor 21 executes the processing of Step S543 because the value of the cursor position entry pointer 123 is “null”.

On the other hand, in a case where the case is not immediately after the cursor initialization, the value of the cursor position entry pointer 123 is not “null” (result of S542 is “NO”), and hence the processor 21 assigns a value of a next entry pointer 211 of an entry 204 corresponding to the cursor position entry pointer 123 of the cursor 120 to the current entry pointer 104 of the thread context 3. The processor 21 assigns a value of an insertion time sequence number 212 of the entry 204 corresponding to the cursor position entry pointer 123 of the cursor 120 to the previous entry insertion time sequence number 106 (S544).

The processor 21 then judges whether or not a value of the current entry pointer 104 is “null” (S545). In a case where the value of the current entry pointer 104 is “null” (result of S545 is “YES”), the processor 21 assigns the value of the current entry pointer 104 to the cursor position entry pointer 123 (S560) to finish the object sequential referring procedure (S554).

In a case where the value of the current entry pointer 104 is not “null” (result of S545 is “NO”), the processor 21 assigns a value of a next entry pointer 211 of the entry 204 corresponding to the current entry pointer 104 to a next entry pointer 105 of the thread context 3, and a current version-entry pointer variable which is one of thread local variables 114 of the thread context 3 with a value of a latest version-entry pointer 231 of the entry corresponding to the current entry pointer (S546). A version-entry 232 corresponding to the current version-entry pointer variable is set as a current version-entry hereinafter.

The processor 21 assigns a value of a version pointer 235 of the current version-entry to a current version pointer variable which is one of thread local variables 114 of the thread context 3, and assigns a value of a version setting time sequence number 233 of the current version-entry to a current entry deletion time sequence number 108 (S547).

The processor 21 assigns a value of an insertion time sequence number 212 of the entry corresponding to the current entry pointer to a current entry insertion time sequence number 107 (S548). The processing of Step S548 is performed for the purpose of judging whether or not an area of the current entry pointer referred to in S546 and S547 has not been reclaimed for reutilization. Thus, depending on a platform, the processor 21 may need a special processor instruction called a fence command to prevent changing of an execution order of Steps S547 and S548 caused by optimization during execution.

The processor 21 judges whether or not the previous entry insertion time sequence number 106 is not the invalid value, and whether or not the previous entry insertion time sequence number 106 is earlier than the current entry insertion time sequence number 107 (S549). In a case where the previous entry insertion time sequence number 106 is not the invalid value, and the previous entry insertion time sequence number 106 is earlier than the current entry insertion time sequence number 107 (result of S549 is “YES”), this means that the entry corresponding to the current entry pointer has been separated from the liked list corresponding to the set and used again. Thus, the processor 21 returns to Step S542 to scan the linked list again from the entry before the cursor movement.

In a case where the previous entry insertion time sequence number 106 is the invalid value or after the current entry insertion time sequence number 107 (result of S549 is “NO”), the processor 21 further judges whether or not a value of the current version-pointer variable is not “null”, and the current entry deletion time sequence number 108 is not the invalid value, and the current entry deletion time sequence number 108 is earlier than a transaction start time sequence number 411 of the transaction management block 410 (S550).

In a case where the condition of S550 is satisfied (result of S550 is “YES”), the current entry pointer is an invalid entry pointer inhibited from being referred to from the cursor because the object has been deleted. Thus, the processor 21 assigns a value of the current entry insertion time sequence number 107 to the previous entry insertion time sequence number 106, and further assigns a value of a next entry pointer 105 to the current entry pointer 104 (S553) to execute processing of S545 and after.

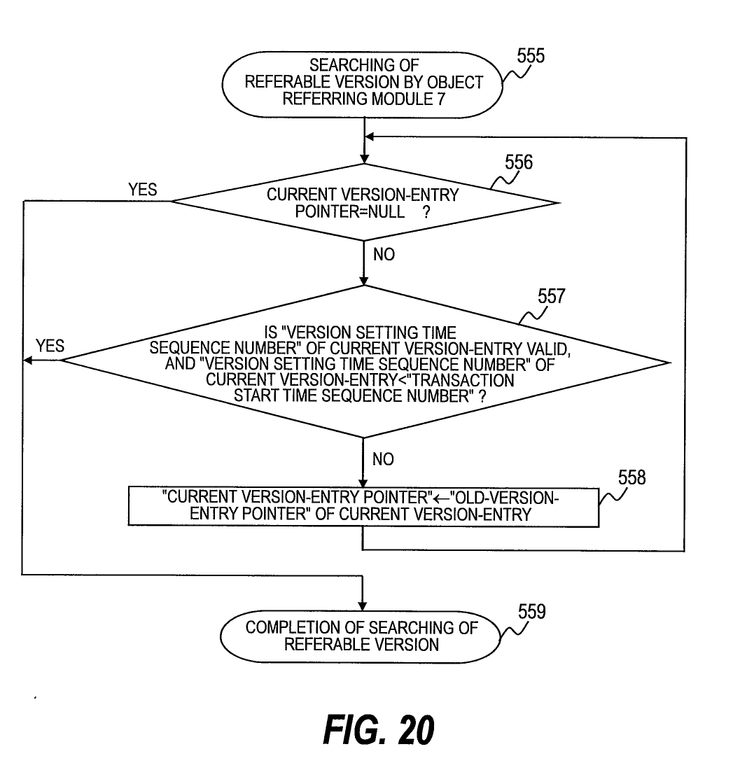

In a case where the condition of S550 is not satisfied (result of S550 is “NO”), the processor 21 searches for a referable version (S551). A procedure for searching for a referable version will be described below referring to FIG. 20. In a case where a referable version is found, the current version-entry pointer variable has been assigned with an address of a corresponding version-entry 232.

The processor 21 judges whether or not a referable version is present, in other words, whether or not a value of the current version-entry pointer variable is “null” (S552). In a case where the value of the current version-entry pointer variable is “null” (result of S552 is “YES”), no referable version is present. Thus, the current entry pointer 104 is changed by executing Step S553 to execute the processing again from Step S545.

In a case where the value of the current version-entry pointer variable is not “null” (result of S552 is “NO”), the current entry pointer is set as a cursor position entry pointer 123 of the cursor 120 (S560). Thus, the processor 21 returns reference to the version 236 of the version-entry 232 corresponding to the current version-entry pointer variable to the application program 4 to finish the object sequential referring procedure (S554).

FIG. 20 is a flowchart illustrating the procedure of searching for a referable version from a transaction according to the second embodiment of this invention.

In a case where searching for a referable version is started by the object sequential referring procedure illustrated in FIG. 19 is started (S555), the processor 21 first checks whether or not a value of the current version-entry pointer is “null” (S556).

In a case where the value of the current version-entry pointer variable is “null” (result of S556 is “YES”), the processor 21 judges that no referable version is present to finish the searching for a referable version (S559).

In a case where the value of the current version-entry pointer variable is not “null” (result of S556 is “NO”), the processor 21 judges whether or not the version setting time sequence number 233 of the current version-entry is valid, and is earlier than the transaction start time sequence number 411 (S557).

In a case where the version setting time sequence number 233 of the current version-entry is valid, and is earlier than the transaction start time sequence number 411 (result of S557 is “YES”), it is understood that a referable version has been found, and hence the processor 21 finishes the searching for a referable version (S559).

In a case where the version setting time sequence number 233 of the current version-entry is invalid or is later than the transaction start time sequence number 411 (result of S557 is “NO”), the processor 21 assigns a value of the old-version-entry 234 of the current version-entry to the current version entry pointer variable (S558) to return to S556.

According to the second embodiment of this invention, even in a system where simultaneous execution control of transactions is executed by MVCC, as in the case of the first embodiment of this invention, high response performance can be obtained without needing any mutually exclusive lock.

While the present invention has been described in detail and pictorially in the accompanying drawings, the present invention is not limited to such detail but covers various obvious modifications and equivalent arrangements, which fall within the purview of the appended claims.

What is claimed is:

1. A data management method which is used in a data management device comprising a data storage unit, an object referring module, and an object area reclaim module, and manages data stored in the data storage unit,
the data corresponding to an entry which includes a reference to another entry and being managed in a set which is a collection of pieces of the data,
the set corresponding to a linked list in which the entry corresponding to the data is linked in order of addition of the data to the set,
the entry including an insertion time sequence number inserted into the linked list and deletion identification information indicating whether or not the data has been deleted from the set,
the data management method including the steps of:
separating, by the object area reclaim module, the entry from the linked list in a thread different from the thread of the object referring module in a case where the data has been deleted from the set;
sequentially referring to, by the object referring module, the data corresponding to the entry by tracing the linked entries from a head entry of the linked list;
comparing, by the object referring module, the insertion time sequence number of a reference entry corresponding to the data to be referred to with the insertion time sequence number of an entry linking the reference entry; and
sequentially referring to, by the object referring module, the data corresponding to the entry from an entry linked to a referred-to entry in which the data has already been referred to in a case where the insertion time sequence number of the reference entry is later than the insertion time sequence number of the entry linking the reference entry.

2. The data management method according to claim 1, wherein:
the data management device further comprises an object insertion module; and
the data management method further includes the step of inserting, by the object insertion module, in a case where new data is added to the set, an entry corresponding to the data to be added to a head of the linked list.

3. The data management method according to claim 1, wherein:
the data management device further comprises an object deletion module; and
the data management method further includes the step of setting, by the object deletion module, the deletion identification information of an entry corresponding to the data to be deleted in a case where the data is deleted from the set.

4. The data management method according to claim 1, wherein:
the entry includes a deletion time sequence number deleted from the set as the deletion identification information; and
the data management method further includes the steps of:
judging, by the object referring module, whether or not the entry has been deleted from the set according to whether or not a valid value is set in the deletion time sequence number;
obtaining, by the object referring module, a referring start time sequence number indicating start of referring to the data included in the linked list; and
referring to, by the object referring module, the data corresponding to the reference entry in a case where no valid value is set in the deletion time sequence number of the reference entry, or the deletion time sequence number is later than the referring start time sequence number.

5. The data management method according to claim 4, further including the step of referring to, by the object referring module, the data corresponding to an entry linked to the reference entry in a case where a valid value is set in the deletion time sequence number of the reference entry, and the deletion time sequence number is earlier than the referring start time sequence number.

6. The data management method according to claim 1, wherein:
the data management device executes a plurality of threads which refer to the data;
the entry includes a deletion time sequence number deleted from the set as the deletion identification information; and
the data management method further includes the steps of:
obtaining, by the object area reclaim module, an earliest time sequence number as an earliest referring time sequence number from among time sequence numbers each indicating a last reference to the linked list in each of the plurality of threads;
sequentially obtaining, by the object area reclaim module, the deletion time sequence number included in the entry by tracing the linked entries from the head entry of the linked list; and
separating, by the object area reclaim module, the entry corresponding to the obtained deletion time sequence number from the linked list in a case where the obtained deletion time sequence number is earlier than the earliest referring time sequence number.

7. The data management method according to claim 6, wherein:
the entry separated from the linked list is reutilized in a case where new data is stored in the set; and
the data management method further includes the step of updating, by the object insertion module, when new data is added to the set, the insertion time sequence number of the entry before an entry corresponding to the data to be added is linked to the linked list.

8. The data management method according to claim 1, wherein:
the entry includes update history of the data corresponding to the entry;
the update history is added with a corresponding version each time the data is updated;
the version includes a version setting time sequence number indicating when the data corresponding to the version is set; and
the deletion identification information is identified as indicating that the entry has been deleted from the set in a case where no data corresponding to a latest version included in the entry is present.

9. The data management method according to claim 8, further including the steps of:
obtaining, by the object referring module, a referring start time sequence number indicating start of referring to the data included in the linked list; and
setting, by the object referring module, from among versions of the reference entry each having the version setting time sequence number earlier than the referring time start sequence number, a latest version as a referring target version, and referring to the data corresponding to the referring target version.

10. The data management method according to claim 9, further including the step of referring to, by the object referring module the data corresponding to the entry linked to the reference entry in a case where no data corresponding to the referring target version is present.

11. The data management method according to claim 8, wherein:
the data management device executes a plurality of threads which refer to the data; and
the data management method further includes the steps of:
obtaining, by the object area reclaim module, an earliest time sequence number as an earliest referring time sequence number from among time sequence numbers each indicating a last reference to the linked list in each of the plurality of threads;
sequentially obtaining, by the object area reclaim module, an entry deleted from the linked list by tracing the linked entries from the head entry of the liked list; and
separating, by the object area reclaim module the obtained entry from the linked list in a case where the deletion time sequence number of the obtained entry is earlier than the earliest referring time sequence number.

12. A storage medium recorded with a data management program which is used in a data management device comprising a data storage unit and an object area reclaim module, and is executed for managing data stored in the data storage unit,
the data corresponding to an entry which includes a reference to another entry and being managed in a set which is a collection of pieces of the data,
the set corresponding to a linked list in which the entry corresponding to the data is linked in order of addition of the data to the set,
the entry including an insertion time sequence number inserted into the linked list and deletion identification information indicating whether or not the data has been deleted from the set,
the object area reclaim module separating the entry from the linked list in a thread different from the thread in which the program is being executed in a case where the data has been deleted from the set,
the program including procedures of:
sequentially referring to the data corresponding to the entry by tracing the linked entries from a head entry of the linked list;
comparing the insertion time sequence number of a reference entry corresponding to the data to be referred to with the insertion time sequence number of an entry linking the reference entry; and
sequentially referring to the data from an entry linked to a referred-to entry in which the data has already been referred to in a case where the insertion time sequence number of the reference entry is later than the insertion time sequence number of the entry linking the reference entry.

13. A data management device, comprising:
a data storage unit;
an object referring module; and
an object area reclaim module,
the data management device managing data stored in the data storage unit, wherein:
the data corresponds to an entry which includes a reference to another entry and is managed in a set which is a collection of pieces of the data;
the set corresponds to a linked list in which the entry corresponding to the data is linked in order of addition of the data to the set;
the entry includes an insertion time sequence number inserted into the linked list and deletion identification information indicating whether or not the data has been deleted from the set;
the object area reclaim module separates the entry from the linked list in a thread different from the thread of the object referring module in a case where the data has been deleted from the set; and
the object referring module is configured to:
sequentially refer to the data corresponding to the entry by tracing the linked entries from a head entry of the linked list;
compare the insertion time sequence number of a reference entry corresponding to the data to be referred to with the insertion time sequence number of an entry linking the reference entry; and
sequentially refer to the data corresponding to the entry from an entry linked to a referred-to entry in which the data has already been referred to in a case where the insertion time sequence number of the reference entry is later than the insertion time sequence number of the entry linking the reference entry.
